(19) United States
(12) Patent Application Publication
(10) Pub. No.: US 2024/0413845 A1
(43) Pub. Date: Dec. 12, 2024

(54) Electronic Devices Having Integrated Amplifier and Coupler Modules

(71) Applicant: Apple Inc., Cupertino, CA (US)

(72) Inventors: Bradley D Scoles, Morgan Hill, CA (US); Christopher J Huber, North Reading, MA (US); Stephan Henzler, Munich (DE); Qishan Yu, San Jose, CA (US)

(21) Appl. No.: 18/641,901

(22) Filed: Apr. 22, 2024

Related U.S. Application Data
(60) Provisional application No. 63/507,370, filed on Jun. 9, 2023.

(51) Int. Cl. H04B 1/00; H04B 1/04

(52) U.S. Cl. CPC H04B 1/006; H04B 1/0078; H04B 1/04; H04B 2001/0408

(57) ABSTRACT

An electronic device may include transceivers, radio-frequency front end (RFFE) circuitry, antennas, and a feedback receiver. The RFFE circuitry may include power amplifier (PA) modules that each transmits radio-frequency signals in a corresponding group of frequency bands. The modules may include power amplifiers, a band selection switch, and an antenna selection switch coupled to the band selection switch over a signal path. A radio-frequency coupler may be disposed on the signal path between the band selection switch and the antenna selection switch. A PA module may include a feedback receiver aggregation switch. The aggregation switch may be coupled to the radio-frequency coupler on its PA module and radio-frequency coupler(s) on other PA modules over feedback paths. The aggregation switch may pass coupled signals from the couplers to the feedback receiver for measurement.

This application claims the benefit of U.S. Provisional Patent Application No. 63/507,370, filed Jun. 9, 2023, which is hereby incorporated by reference herein in its entirety.

### FIELD

This disclosure relates generally to electronic devices and, more particularly, to electronic devices with wireless communications circuitry.

### BACKGROUND

Electronic devices are often provided with wireless communications capabilities. An electronic device with wireless communications capabilities has wireless communications circuitry with an antenna.

During wireless transmission, it can be desirable for the wireless communications circuitry to be able to measure radio-frequency signals transmitted over the antenna. However, in practice, it can be difficult to measure the radio-frequency signals without deteriorating wireless performance and while minimizing the size, complexity, and cost of the device.

### SUMMARY

An electronic device may include wireless circuitry for performing wireless communications. The wireless circuitry may include one or more transceivers, radio-frequency front end (RFFE) circuitry, a set of antennas, and a feedback receiver. The one or more transceivers may transmit radio-frequency signals using the RFFE circuitry and the set of antennas.

The RFFE circuitry may include a set of RFFE modules. The RFFE modules may include power amplifier (PA) modules. Each PA module may transmit radio-frequency signals in a corresponding frequency band or group of frequency bands. The PA modules may include a band selection switch and an antenna selection switch. The output of the band selection switch may be coupled to the input of the antenna selection switch over a signal path. The band selection switch may have inputs coupled to power amplifiers. The antenna selection switch may have outputs communicatively coupled to two or more of the antennas. Filter modules may be coupled between the outputs of the antenna selection switch and the antennas. The filter modules may couple different PA modules to the same antenna(s).

The RFFE circuitry may include radio-frequency couplers integrated into the PA modules. The radio-frequency coupler may be disposed on the signal path between the band selection switch and the antenna selection switch or at the output of the power amplifiers. One or more of the PA modules may include a feedback receiver aggregation switch. The aggregation switch may be coupled to the radio-frequency coupler on its PA module and the radio-frequency coupler(s) on one or more other PA modules over feedback paths. The aggregation switch may pass coupled signals from one or more of the radio-frequency couplers to the feedback receiver. The feedback receiver may measure the coupled signals to perform transmit power level adjustments, measure antenna impedances, etc. This may serve to reduce space consumption and cost, to reduce the number of required radio-frequency couplers, and to increase noise isolation in the coupled signals passed to the feedback receiver (e.g., without requiring additional filtering) relative to scenarios where the radio-frequency couplers are implemented using dedicated coupler modules disposed between the filter modules and the antennas.

An aspect of the disclosure provides an electronic device. The electronic device can include a first antenna. The electronic device can include a second antenna. The electronic device can include a first switch having a first input terminal, a second input terminal, and a first output terminal, the first input terminal being configured to receive a radio-frequency signal of a first frequency and the second input terminal being configured to receive a radio-frequency signal of a second frequency different from the first frequency. The electronic device can include a second switch having a third input terminal, a second output terminal, and a third output terminal, the third input terminal being coupled to the first output terminal over a signal path, the second output terminal being communicatively coupled to the first antenna, and the third output terminal being communicatively coupled to the second antenna. The electronic device can include a radio-frequency coupler disposed on the signal path between the first switch and the second switch.

An aspect of the disclosure provides radio-frequency front end (RFFE) circuitry. The RFFE circuitry can include a substrate. The RFFE circuitry can include a band selection switch on the substrate. The RFFE circuitry can include a plurality of power amplifiers on the substrate, each coupled to a respective input terminal of the band selection switch and each configured to amplify radio-frequency signals of a different respective frequency. The RFFE circuitry can include a signal path on the substrate and coupled to an output terminal of the band selection switch. The RFFE circuitry can include an antenna selection switch on the substrate and having an input terminal coupled to the signal path, the antenna selection switch being configured to route the radio-frequency signals from the signal path to a selected antenna of a plurality of antennas. The RFFE circuitry can include a radio-frequency coupler on the substrate and disposed on the signal path.

An aspect of the disclosure provides a method of operating an electronic device to wirelessly transmit a radio-frequency signal. The method can include amplifying, using a power amplifier, the radio-frequency signal. The method can include transmitting, using a first switch, the radio-frequency signal from the power amplifier onto a signal path. The method can include coupling, using a radio-frequency coupler, a portion of the radio-frequency signal off the signal path. The method can include transmitting, using a second switch, the radio-frequency signal from the signal path towards a selected antenna of a plurality of antennas. The method can include filtering the radio-frequency signal using a filter coupled between the second switch and the selected antenna. The method can include transmitting, using the selected antenna, the radio-frequency signal.

### BRIEF DESCRIPTION OF THE DRAWINGS

FIG. 1 is a perspective view of an illustrative electronic device in accordance with some embodiments.

FIG. 2 is a schematic diagram of illustrative circuitry in an electronic device in accordance with some embodiments.

FIG. 3 is a top interior view of an illustrative electronic device having antennas at different locations within the electronic device in accordance with some embodiments.

FIGS. 4 and 5 are circuit diagrams of illustrative radio-frequency front end circuitry having integrated radio-frequency couplers and feedback receiver aggregation switches in accordance with some embodiments.

FIG. 6 is a flow chart of illustrative operations involved in using an electronic device having radio-frequency front end circuitry with integrated radio-frequency couplers and feedback receiver aggregation switches to convey radio-frequency signals in accordance with some embodiments.

### DETAILED DESCRIPTION

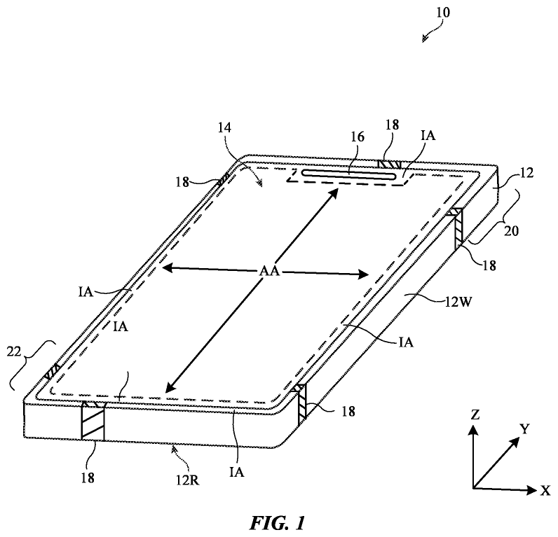

An electronic device such as electronic device 10 of FIG. 1 may be provided with wireless circuitry that includes antennas. The antennas may be used to transmit and/or receive wireless radio-frequency signals.

Device 10 may be a portable electronic device or other suitable electronic device. For example, device 10 may be a laptop computer, a tablet computer, a somewhat smaller device such as a wrist-watch device, pendant device, headphone device, earpiece device, headset device, or other wearable or miniature device, a handheld device such as a cellular telephone, a media player, or other small portable device. Device 10 may also be a set-top box, a desktop computer, a display into which a computer or other processing circuitry has been integrated, a display without an integrated computer, a wireless access point, a wireless base station, an electronic device incorporated into a kiosk, building, or vehicle, or other suitable electronic equipment.

Device 10 may include a housing such as housing 12. Housing 12, which may sometimes be referred to as a case, may be formed of plastic, glass, ceramics, fiber composites, metal (e.g., stainless steel, aluminum, etc.), other suitable materials, or a combination of these materials. In some situations, parts of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may, if desired, have a display such as display 14. Display 14 may be mounted on the front face of device 10. Display 14 may be a touch screen that incorporates capacitive touch electrodes or may be insensitive to touch. The rear face of housing 12 (i.e., the face of device 10 opposing the front face of device 10) may have a substantially planar housing wall such as rear housing wall 12R (e.g., a planar housing wall). Rear housing wall 12R may have slots that pass entirely through the rear housing wall and that therefore separate portions of housing 12 from each other. Rear housing wall 12R may include conductive portions and/or dielectric portions. If desired, rear housing wall 12R may include a planar metal layer covered by a thin layer or coating of dielectric such as glass, plastic, sapphire, or ceramic (e.g., a dielectric cover layer). Housing 12 may also have shallow grooves that do not pass entirely through housing 12. The slots and grooves may be filled with plastic or other dielectric materials. If desired, portions of housing 12 that have been separated from each other (e.g., by a through slot) may be joined by internal conductive structures (e.g., sheet metal or other metal members that bridge the slot).

Housing 12 may include peripheral housing structures such as peripheral structures 12W. Conductive portions of peripheral structures 12W and conductive portions of rear housing wall 12R may sometimes be referred to herein collectively as conductive structures of housing 12. Peripheral structures 12W may run around the periphery of device 10 and display 14. In configurations in which device 10 and display 14 have a rectangular shape with four edges, peripheral structures 12W may be implemented using peripheral housing structures that have a rectangular ring shape with four corresponding edges and that extend from rear housing wall 12R to the front face of device 10 (as an example). In other words, device 10 may have a length (e.g., measured parallel to the Y-axis), a width that is less than the length (e.g., measured parallel to the X-axis), and a height (e.g., measured parallel to the Z-axis) that is less than the width. Peripheral structures 12W or part of peripheral structures 12W may serve as a bezel for display 14 (e.g., a cosmetic trim that surrounds all four sides of display 14 and/or that helps hold display 14 to device 10) if desired. Peripheral structures 12W may, if desired, form sidewall structures for device 10 (e.g., by forming a metal band with vertical sidewalls, curved sidewalls, etc.).

Peripheral structures 12W may be formed from a conductive material such as metal and may therefore sometimes be referred to as peripheral conductive housing structures, conductive housing structures, peripheral metal structures, peripheral conductive sidewalls, peripheral conductive sidewall structures, conductive housing sidewalls, peripheral conductive housing sidewalls, sidewalls, sidewall structures, or a peripheral conductive housing member (as examples). Peripheral conductive housing structures 12W may be formed from a metal such as stainless steel, aluminum, alloys, or other suitable materials. One, two, or more than two separate structures may be used in forming peripheral conductive housing structures 12W.

It is not necessary for peripheral conductive housing structures 12W to have a uniform cross-section. For example, the top portion of peripheral conductive housing structures 12W may, if desired, have an inwardly protruding ledge that helps hold display 14 in place. The bottom portion of peripheral conductive housing structures 12W may also have an enlarged lip (e.g., in the plane of the rear surface of device 10). Peripheral conductive housing structures 12W may have substantially straight vertical sidewalls, may have sidewalls that are curved, or may have other suitable shapes. In some configurations (e.g., when peripheral conductive housing structures 12W serve as a bezel for display 14), peripheral conductive housing structures 12W may run around the lip of housing 12 (i.e., peripheral conductive housing structures 12W may cover only the edge of housing 12 that surrounds display 14 and not the rest of the sidewalls of housing 12).

Rear housing wall 12R may lie in a plane that is parallel to display 14. In configurations for device 10 in which some or all of rear housing wall 12R is formed from metal, it may be desirable to form parts of peripheral conductive housing structures 12W as integral portions of the housing structures forming rear housing wall 12R. For example, rear housing wall 12R of device 10 may include a planar metal structure and portions of peripheral conductive housing structures 12W on the sides of housing 12 may be formed as flat or curved vertically extending integral metal portions of the planar metal structure (e.g., housing structures 12R and 12W may be formed from a continuous piece of metal in a unibody configuration). Housing structures such as these may, if desired, be machined from a block of metal and/or may include multiple metal pieces that are assembled together to form housing 12. Rear housing wall 12R may have one or more, two or more, or three or more portions. Peripheral conductive housing structures 12W and/or conductive portions of rear housing wall 12R may form one or more exterior surfaces of device 10 (e.g., surfaces that are visible to a user of device 10) and/or may be implemented using internal structures that do not form exterior surfaces of device 10 (e.g., conductive housing structures that are not visible to a user of device 10 such as conductive structures that are covered with layers such as thin cosmetic layers, protective coatings, and/or other coating/cover layers that may include dielectric materials such as glass, ceramic, plastic, or other structures that form the exterior surfaces of device 10 and/or serve to hide peripheral conductive housing structures 12W and/or conductive portions of rear housing wall 12R from view of the user).

Display 14 may have an array of pixels that form an active area AA that displays images for a user of device 10. For example, active area AA may include an array of display pixels. The array of pixels may be formed from liquid crystal display (LCD) components, an array of electrophoretic pixels, an array of plasma display pixels, an array of organic light-emitting diode display pixels or other light-emitting diode pixels, an array of electrowetting display pixels, or display pixels based on other display technologies. If desired, active area AA may include touch sensors such as touch sensor capacitive electrodes, force sensors, or other sensors for gathering a user input.

Display 14 may have an inactive border region that runs along one or more of the edges of active area AA. Inactive area IA of display 14 may be free of pixels for displaying images and may overlap circuitry and other internal device structures in housing 12. To block these structures from view by a user of device 10, the underside of the display cover layer or other layers in display 14 that overlap inactive area IA may be coated with an opaque masking layer in inactive area IA. The opaque masking layer may have any suitable color. Inactive area IA may include a recessed region such as notch 24 that extends into active area AA. Active area AA may, for example, be defined by the lateral area of a display module for display 14 (e.g., a display module that includes pixel circuitry, touch sensor circuitry, etc.). The display module may have a recess or notch in upper region 20 of device 10 that is free from active display circuitry (i.e., that forms notch 24 of inactive area IA). Notch 24 may be a substantially rectangular region that is surrounded (defined) on three sides by active area AA and on a fourth side by peripheral conductive housing structures 12W. One or more sensors may be aligned with notch 24 and may transmit and/or receive light through display 14 within notch 24.

Display 14 may be protected using a display cover layer such as a layer of transparent glass, clear plastic, transparent ceramic, sapphire, or other transparent crystalline material, or other transparent layer(s). The display cover layer may have a planar shape, a convex curved profile, a shape with planar and curved portions, a layout that includes a planar main area surrounded on one or more edges with a portion that is bent out of the plane of the planar main area, or other suitable shapes. The display cover layer may cover the entire front face of device 10. In another suitable arrangement, the display cover layer may cover substantially all of the front face of device 10 or only a portion of the front face of device 10. Openings may be formed in the display cover layer. For example, an opening may be formed in the display cover layer to accommodate a button. An opening may also be formed in the display cover layer to accommodate ports such as speaker port 16 in notch 24 or a microphone port. Openings may be formed in housing 12 to form communications ports (e.g., an audio jack port, a digital data port, etc.) and/or audio ports for audio components such as a speaker and/or a microphone if desired.

Display 14 may include conductive structures such as an array of capacitive electrodes for a touch sensor, conductive lines for addressing pixels, driver circuits, etc. Housing 12 may include internal conductive structures such as metal frame members and a planar conductive housing member (sometimes referred to as a conductive support plate or backplate) that spans the walls of housing 12 (e.g., a substantially rectangular sheet formed from one or more metal parts that is welded or otherwise connected between opposing sides of peripheral conductive housing structures 12W). The conductive support plate may form an exterior rear surface of device 10 or may be covered by a dielectric cover layer such as a thin cosmetic layer, protective coating, and/or other coatings that may include dielectric materials such as glass, ceramic, plastic, or other structures that form the exterior surfaces of device 10 and/or serve to hide the conductive support plate from view of the user (e.g., the conductive support plate may form part of rear housing wall 12R). Device 10 may also include conductive structures such as printed circuit boards, components mounted on printed circuit boards, and other internal conductive structures. These conductive structures, which may be used in forming a ground plane in device 10, may extend under active area AA of display 14, for example.

In regions 22 and 20, openings may be formed within the conductive structures of device 10 (e.g., between peripheral conductive housing structures 12W and opposing conductive ground structures such as conductive portions of rear housing wall 12R, conductive traces on a printed circuit board, conductive electrical components in display 14, etc.). These openings, which may sometimes be referred to as gaps, may be filled with air, plastic, and/or other dielectrics and may be used in forming slot antenna resonating elements for one or more antennas in device 10, if desired.

Conductive housing structures and other conductive structures in device 10 may serve as a ground plane for the antennas in device 10. The openings in regions 22 and 20 may serve as slots in open or closed slot antennas, may serve as a central dielectric region that is surrounded by a conductive path of materials in a loop antenna, may serve as a space that separates an antenna resonating element such as a strip antenna resonating element or an inverted-F antenna resonating element from the ground plane, may contribute to the performance of a parasitic antenna resonating element, or may otherwise serve as part of antenna structures formed in regions 22 and 20. If desired, the ground plane that is under active area AA of display 14 and/or other metal structures in device 10 may have portions that extend into parts of the ends of device 10 (e.g., the ground may extend towards the dielectric-filled openings in regions 22 and 20), thereby narrowing the slots in regions 22 and 20. Region 22 may sometimes be referred to herein as lower region 22 or lower end 22 of device 10. Region 20 may sometimes be referred to herein as upper region 20 or upper end 20 of device 10.

In general, device 10 may include any suitable number of antennas (e.g., one or more, two or more, three or more, four or more, etc.). The antennas in device 10 may be located at opposing first and second ends of an elongated device housing (e.g., at lower region 22 and/or upper region 20 of device 10 of FIG. 1), along one or more edges of a device housing, in the center of a device housing, in other suitable locations, or in one or more of these locations. The arrangement of FIG. 1 is illustrative and non-limiting.

Portions of peripheral conductive housing structures 12W may be provided with peripheral gap structures. For example, peripheral conductive housing structures 12W may be provided with one or more dielectric-filled gaps such as gaps 18, as shown in FIG. 1. The gaps in peripheral conductive housing structures 12W may be filled with dielectric such as polymer, ceramic, glass, air, other dielectric materials, or combinations of these materials. Gaps 18 may divide peripheral conductive housing structures 12W into one or more peripheral conductive segments. The conductive segments that are formed in this way may form parts of antennas in device 10 if desired. Other dielectric openings may be formed in peripheral conductive housing structures 12W (e.g., dielectric openings other than gaps 18) and may serve as dielectric antenna windows for antennas mounted within the interior of device 10. Antennas within device 10 may be aligned with the dielectric antenna windows for conveying radio-frequency signals through peripheral conductive housing structures 12W. Antennas within device 10 may also be aligned with inactive area IA of display 14 for conveying radio-frequency signals through display 14.

To provide an end user of device 10 with as large of a display as possible (e.g., to maximize an area of the device used for displaying media, running applications, etc.), it may be desirable to increase the amount of area at the front face of device 10 that is covered by active area AA of display 14. Increasing the size of active area AA may reduce the size of inactive area IA within device 10. This may reduce the area behind display 14 that is available for antennas within device 10. For example, active area AA of display 14 may include conductive structures that serve to block radio-frequency signals handled by antennas mounted behind active area AA from radiating through the front face of device 10. It would therefore be desirable to be able to provide antennas that occupy a small amount of space within device 10 (e.g., to allow for as large of a display active area AA as possible) while still allowing the antennas to communicate with wireless equipment external to device 10 with satisfactory efficiency bandwidth.

In a typical scenario, device 10 may have one or more upper antennas and one or more lower antennas. An upper antenna may, for example, be formed in upper region 20 of device 10. A lower antenna may, for example, be formed in lower region 22 of device 10. Additional antennas may be formed along the edges of housing 12 extending between regions 20 and 22 if desired. The antennas may be used separately to cover identical communications bands, overlapping communications bands, or separate communications bands. The antennas may be used to implement an antenna diversity scheme or a multiple-input-multiple-output (MIMO) antenna scheme. Other antennas for covering any other desired frequencies may also be mounted at any desired locations within the interior of device 10. The example of FIG. 1 is illustrative and non-limiting. If desired, housing 12 may have other shapes (e.g., a square shape, cylindrical shape, spherical shape, combinations of these and/or different shapes, etc.).

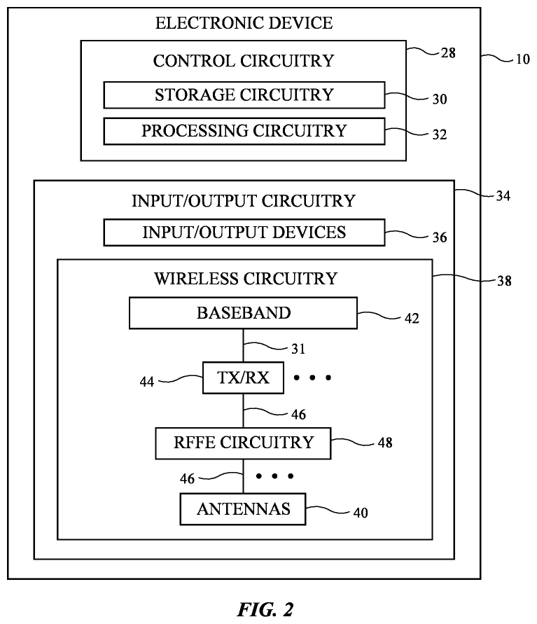

A schematic diagram of illustrative components that may be used in device 10 is shown in FIG. 2. As shown in FIG. 2, device 10 may include control circuitry 28. Control circuitry 28 may include storage such as storage circuitry 30. Storage circuitry 30 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 30 may include storage that is integrated within device 10 and/or removable storage media.

Control circuitry 28 may include processing circuitry such as processing circuitry 32. Processing circuitry 32 may be used to control the operation of device 10. Processing circuitry 32 may include on one or more processors such as microprocessors, microcontrollers, digital signal processors, host processors, baseband processor integrated circuits, application specific integrated circuits, central processing units (CPUs), graphics processing units (GPUs), etc. Control circuitry 28 may be configured to perform operations in device 10 using hardware (e.g., dedicated hardware or circuitry), firmware, and/or software. Software code for performing operations in device 10 may be stored on storage circuitry 30 (e.g., storage circuitry 30 may include non-transitory (tangible) computer readable storage media that stores the software code). The software code may sometimes be referred to as program instructions, software, data, instructions, or code. Software code stored on storage circuitry 30 may be executed by processing circuitry 32.

Control circuitry 28 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 28 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband (UWB) protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol (e.g., a WLAN RAT, a WPAN RAT, a cellular telephone RAT such as a 4G RAT. 5G RAT, 3G RAT. 6G RAT, etc., a UWB RAT, etc.).

Device 10 may include input-output circuitry 34. Input-output circuitry 34 may include input-output devices 36. Input-output devices 36 may be used to allow data to be supplied to device 10 and to allow data to be provided from device 10 to external devices. Input-output devices 36 may include user interface devices, data port devices, and other input-output components. For example, input-output devices 36 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 36 may be peripherals that are coupled to a main processing unit or other portion of device 10 via a wired or wireless link).

Input-output circuitry 34 may include wireless circuitry 38 to support wireless communications. Wireless circuitry 38 (sometimes referred to herein as wireless communications circuitry 38) may include baseband circuitry such as baseband circuitry 42 (e.g., one or more baseband processors and/or other circuitry that operates at baseband), radio-frequency (RF) transceiver circuitry such as one or more transceivers (TX/RX) 44, radio-frequency front end (RFFE) circuitry such as RFFE circuitry 48, and one or more antennas 40. If desired, wireless circuitry 38 may include multiple antennas 40 that are arranged into a phased antenna array (sometimes referred to as a phased array antenna) that conveys radio-frequency signals within a corresponding signal beam that can be steered in different directions.

Baseband circuitry 42 may be coupled to transceiver(s) 44 over one or more baseband signal paths 31. Baseband circuitry 42 may include, for example, modulators (encoders) and demodulators (decoders) that operate on baseband signals. Transceiver(s) 44 may sometimes also be referred to herein as radio(s) 44. Each transceiver 44 may be coupled to one or more antennas 40 over one or more radio-frequency transmission line paths 46 (sometimes referred to herein as radio-frequency signal paths 46). RFFE circuitry 48 may be disposed on one or more radio-frequency transmission line paths 46 between one or more transceivers 44 and one or more antennas 40.

Each transceiver 44 may include a transmitter and/or receiver that transmits and/or receives radio-frequency signals. Each transceiver 44 may convey radio-frequency signals using one or more corresponding RATs. If desired, different transceivers 44 may convey radio-frequency signals using different RATs (e.g., a first transceiver 44 may convey cellular telephone signals, a second transceiver 44 may convey Wi-Fi signals, etc.). If desired, the same transceiver 44 may convey radio-frequency signals using two or more RATs (e.g., a given transceiver 44 may convey both Wi-Fi and Bluetooth signals, a given transceiver 44 may convey both 4G cellular telephone signals and 5G cellular telephone signals, a given transceiver 44 may both convey cellular telephone signals and receive satellite navigation signals, etc.).

Each transceiver 44 may be coupled to the same antenna 40 over different radio-frequency transmission line paths 46, two or more transceivers 44 may be coupled to the same antenna 40 over the same radio-frequency transmission line path, a given transceiver 44 may be coupled to different antennas over different radio-frequency transmission line paths, etc. In general, any desired number of one or more radio-frequency transmission line paths 46 may be used to couple one or more transceivers 44 to one or more antennas 40 and, if desired, two or more transceivers 44 may be coupled to the same antenna(s) 40 over the same radio-frequency transmission line path(s) 46. Any desired number of two or more of the transceivers 44 in wireless circuitry 38 may be coupled to the same RFFE circuitry 48 (e.g., RFFE circuitry 48 disposed on the one or more radio-frequency transmission line paths 46 coupling the two or more transceivers 44 to one or more antennas 40) or different respective transceivers 44 may be coupled to different respective RFFE circuitry 48. In general, wireless circuitry 38 may include any desired number of transceivers 44, any desired number of radio-frequency transmission line paths 46, and any desired number of antennas 40.

Radio-frequency transmission line path(s) 46 may be coupled to antenna feeds on one or more antennas 40. Each antenna feed may, for example, include a positive antenna feed terminal and a ground antenna feed terminal. Each radio-frequency transmission line path 46 may have a positive transmission line signal path that is coupled to one or more positive antenna feed terminals and may have a ground transmission line signal path that is coupled to the ground antenna feed terminal. This example is merely illustrative and, in general, antennas 40 may be fed using any desired antenna feeding scheme.

Each radio-frequency transmission line path 46 may include one or more radio-frequency transmission lines that are used to route radio-frequency signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Radio-frequency transmission line paths 46 may also include radio-frequency connectors that couple multiple transmission lines together. Transmission lines in device 10 such as transmission lines in a radio-frequency transmission line path 46 may be integrated into rigid and/or flexible printed circuit boards. In some implementations, radio-frequency transmission line paths such as radio-frequency transmission line path 46 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 42 may provide baseband signals to a transceiver 44 over baseband signal path(s) 31. Transceiver 44 (e.g., one or more transmitters in transceiver 44) may include circuitry for converting the baseband signals received from baseband circuitry 42 into corresponding radio-frequency signals. For example, transceiver 44 may include mixer circuitry for up-converting the baseband signals to radio frequencies prior to transmission over antenna(s) 40. Transceiver 44 may also include digital to analog converter (DAC) and/or analog to digital converter (ADC) circuitry for converting signals between digital and analog domains. Transceiver 44 may transmit the radio-frequency signals over antenna(s) 40 via one or more radio-frequency transmission line paths 46 and RFFE circuitry 48. Antenna(s) 40 may transmit the radio-frequency signals to external wireless equipment (e.g., a wireless access point, a wireless base station, another device 10, an accessory device, a peripheral device, a head-mounted device, a communications satellite, etc.) by radiating the radio-frequency signals into free space.

In performing wireless reception, antenna(s) 40 may receive radio-frequency signals from the external wireless equipment. The received radio-frequency signals may be conveyed to a corresponding transceiver 44 via radio-frequency transmission line path(s) 46 and RFFE circuitry 48. Transceiver 44 may include circuitry for converting the received radio-frequency signals into corresponding baseband signals. For example, transceiver 44 may include one or more receivers having mixer circuitry for down-converting the received radio-frequency signals to baseband frequencies prior to conveying the baseband signals to baseband circuitry 42.

RFFE circuitry 48 may include radio-frequency front end components that operate on radio-frequency signals conveyed over the corresponding radio-frequency transmission line path(s) 46. RFFE circuitry 48 may include one or more RFFE modules. Each RFFE module may include corresponding radio-frequency components for operating on radio-frequency signals within a corresponding set of one or more frequency bands and/or for a corresponding set of one or more antennas 40. RFFE circuitry 48 may sometimes also be referred to herein simply as radio-frequency front end 48.

Each RFFE module in RFFE circuitry 48 may include corresponding radio-frequency components mounted a different respective substrate such as a printed circuit board substrate (e.g., a rigid or flexible printed circuit board). If desired, one or more of the RFFE modules may be a multi-chip module (MCM). The radio-frequency components of each RFFE module may be formed from one or more integrated circuits and/or surface mount components (e.g., surface mount technology (SMT) components) mounted (e.g., soldered) to the corresponding substrate of that RFFE module, may be printed onto the substrate, may be embedded within the substrate, etc. Each RFFE module may include respective control circuitry, a respective control interface, a respective power interface (e.g., power supply pins), respective I/O pins, a respective digital interface, etc.

The radio-frequency front end components in each RFFE module of RFFE circuitry 48 may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, switchplexer circuitry, etc.), impedance matching circuitry (e.g., circuitry that helps to match the impedance of antenna(s) 40 to the impedance of radio-frequency transmission line path(s) 46, circuitry that helps to match the impedance of some components in RFFE circuitry 48 to other components in RFFE circuitry 48, etc.), antenna tuning circuitry (e.g., networks of capacitors, resistors, inductors, and/or switches that adjust the frequency response of antennas 40), radio-frequency amplifier circuitry (e.g., power amplifier (PA) circuitry such as one or more power amplifiers and/or low-noise amplifier (LNA) circuitry such as one or more low noise amplifiers), radio-frequency (RF) coupler circuitry, power detector (PD) circuitry such as one or more power detectors 38, charge pump circuitry, power management circuitry, low dropout (LDO) regulator circuitry, digital control and interface circuitry, and/or any other desired circuitry that operates on the radio-frequency signals transmitted and/or received by the antenna(s) 40 coupled to RFFE circuitry 48 over the corresponding radio-frequency transmission line path(s) 46.

While control circuitry 28 is shown separately from wireless circuitry 38 in the example of FIG. 2 for the sake of clarity, wireless circuitry 38 may include processing circuitry that forms a part of processing circuitry 32 and/or storage circuitry that forms a part of storage circuitry 30 of control circuitry 28 (e.g., portions of control circuitry 28 may be implemented on wireless circuitry 38). As an example, baseband circuitry 42 and/or portions of transceiver(s) 44 (e.g., a host processor on transceiver(s) 44) may form a part of control circuitry 28.

Wireless circuitry 38 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHZ WLAN band (e.g., from 2400 to 2480 MHZ), a 5 GHZ WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHZ Bluetooth® band or other WPAN communications bands, cellular telephone communications bands such as a cellular low band (LB) (e.g., a band between about 600 to 960 MHz), a cellular low-midband (LMB) (e.g., a band between about 1400 to 1550 MHZ), a cellular midband (MB) (e.g., a band between about 1700 to 2200 MHz), a cellular high band (HB) (e.g., a band between 2300 to 2700 MHZ), a cellular ultra-high band (UHB) (e.g., a band from 3300 to 5000 MHz, or other cellular communications bands between about 600 MHz and about 5000 MHZ), 3G bands, 4G LTE bands, 5G New Radio Frequency Range 1 (FR1) bands below 10 GHZ, 5G New Radio Frequency Range 2 (FR2) bands between 20 and 60 GHZ, other centimeter or millimeter wave frequency bands between 10-100 GHz, near-field communications (NFC) frequency bands (e.g., at 13.56 MHZ), satellite navigation frequency bands (e.g., a GPS band from 1565 to 1610 MHZ, a Global Navigation Satellite System (GLONASS) band, a BeiDou Navigation Satellite System (BDS) band, ultra-wideband (UWB) frequency bands that operate under the IEEE 802.15.4 protocol and/or other ultra-wideband communications protocols (e.g., a first UWB communications band at 6.5 GHZ and/or a second UWB communications band at 8.0 GHZ), communications bands under the family of 3GPP wireless communications standards, communications bands under the IEEE 802.XX family of standards, satellite communications bands such as an L-band, S-band (e.g., from 2-4 GHZ), C-band (e.g., from 4-8 GHZ), X-band, Ku-band (e.g., from 12-18 GHz), Ka-band (e.g., from 26-40 GHZ), etc., industrial, scientific, and medical (ISM) bands such as an ISM band between around 900 MHz and 950 MHz or other ISM bands below or above 1 GHZ, one or more unlicensed bands, one or more bands reserved for emergency and/or public services, and/or any other desired frequency bands of interest. Each radio 28 may transmit and/or receive radio-frequency signals in one or more of these frequency bands.

Antennas 40 may be formed using any desired antenna structures. For example, antennas 40 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. Parasitic elements may be included in antennas 40 to adjust antenna performance.

Filter circuitry, switching circuitry, impedance matching circuitry, and other circuitry may be interposed within radio-frequency transmission line path(s) 46, may be incorporated into RFFE circuitry 48, and/or may be incorporated into antenna(s) 40 (e.g., to support antenna tuning, to support operation in desired frequency bands, etc.). These components, sometimes referred to herein as antenna tuning components, may be adjusted (e.g., using control circuitry 28) to adjust the frequency response and wireless performance of antennas 40 over time.

In general, each transceiver 44 may cover (handle) any suitable communications (frequency) bands of interest. The transceiver may convey radio-frequency signals using antenna(s) 40 (e.g., antenna(s) 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antennas.

In example where multiple antennas 40 are arranged in a phased antenna array, each antenna 40 may form a respective antenna element of the phased antenna array. Conveying radio-frequency signals using the phased antenna array may allow for greater peak signal gain relative to scenarios where individual antennas 40 are used to convey radio-frequency signals. In satellite navigation system links, cellular telephone links, and other long-range links, radio-frequency signals are typically used to convey data over thousands of feet or miles. In Wi-Fi® and Bluetooth® links at 2.4 and 5 GHz and other short-range wireless links, radio-frequency signals are typically used to convey data over tens or hundreds of feet. In scenarios where millimeter or centimeter wave frequencies are used to convey radio-frequency signals, a phased antenna array may convey radio-frequency signals over short distances that travel over a line-of-sight path. To enhance signal reception for millimeter and centimeter wave communications, the phased antenna array may convey radio-frequency signals using beam steering techniques (e.g., schemes in which antenna signal phase and/or magnitude for each antenna in an array are adjusted to perform beam steering).

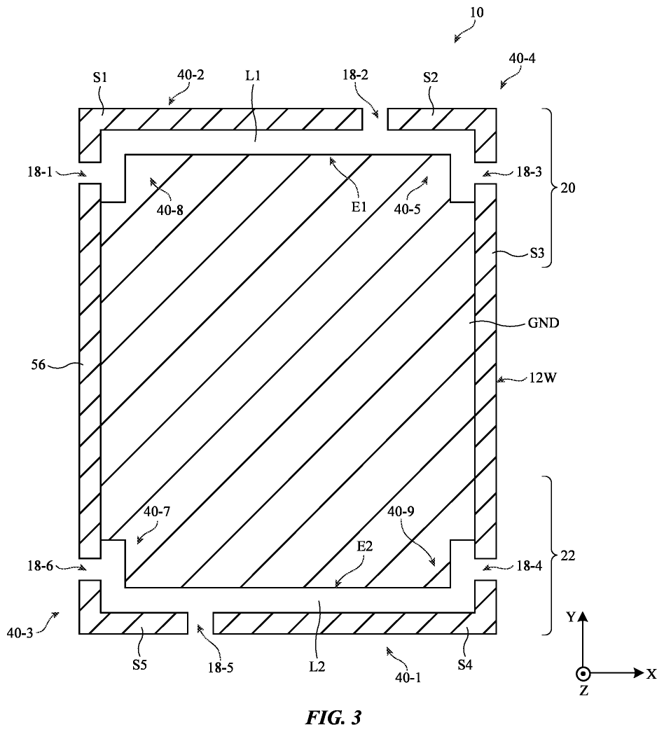

In general, device 10 may include any desired number of antennas. The antennas may be disposed at different locations on device 10. If desired, the antennas may support antenna diversity (e.g., in which different or best-performing antennas are switched into use for covering a particular frequency band at a given time given the current operating conditions of device 10) and/or multiple-input and multiple-output (MIMO) schemes (e.g., in which multiple antennas concurrent transmit or receive wireless data to maximize data throughput). FIG. 3 is a top interior view of device 10 showing how different antennas 40 may be disposed at different locations in device 10.

As shown in FIG. 3, peripheral conductive housing structures 12W of device 10 may include a first conductive sidewall at the left edge of device 10, a second conductive sidewall at the top edge of device 10, a third conductive sidewall at the right edge of device 10, and a fourth conductive sidewall at the bottom edge of device 10 (e.g., in an example where device 10 has a substantially rectangular lateral shape). Peripheral conductive housing structures 12W may be segmented by dielectric-filled gaps 18 such as a first gap 18-1, a second gap 18-2, a third gap 18-3, a fourth gap 18-4, a fifth gap 18-5, and a sixth gap 18-6. Gaps 18-1, 18-2, 18-3, 18-4, 18-5, and 18-6 may be filled with plastic, ceramic, sapphire, glass, epoxy, or other dielectric materials. The dielectric material in the gaps may lie flush with peripheral conductive housing structures 12W at the exterior surface of device 10 if desired. Peripheral conductive housing structures 12W may include additional gaps 18 or fewer than six gaps 18 if desired.

Gap 18-1 may divide the first conductive sidewall to separate segment S6 of peripheral conductive housing structures 12W from segment S1 of peripheral conductive housing structures 12W. Gap 18-2 may divide the second conductive sidewall to separate segment S1 from segment S2 of peripheral conductive housing structures 12W. Gap 18-3 may divide the third conductive sidewall to separate segment S2 from segment S3 of peripheral conductive housing structures 12W. Gap 18-4 may divide the third conductive sidewall to separate segment S3 from segment S4 of peripheral conductive housing structures 12W. Gap 18-5 may divide the fourth conductive sidewall to separate segment S4 from segment S5 of peripheral conductive housing structures 12W. Gap 18-6 may divide the first conductive sidewall to separate segment S5 from segment S6.

In this example, segment S1 forms the top-left corner of device 10 (e.g., segment S1 may have a bend at the corner) and is formed from the first and second conductive sidewalls of peripheral conductive housing structures 12W (e.g., in upper region 20 of device 10). Segment S2 forms the top-right corner of device 10 (e.g., segment S2 may have a bend at the corner) and is formed from the second and third conductive sidewalls of peripheral conductive housing structures 12W (e.g., in upper region 20 of device 10). Segment S4 forms the bottom-right corner of device 10 and is formed from the third and fourth conductive sidewalls of peripheral conductive housing structures 12W (e.g., in lower region 22 of device 10). Segment S5 forms the bottom-left corner of device 10 and is formed from the fourth and first conductive sidewalls of peripheral conductive housing structures 12W (e.g., in lower region 22 of device 10).

Ground structures GND may extend between opposing sidewalls of peripheral conductive housing structures 12W. For example, ground structures GND may extend from segment S6 to segment S3 of peripheral conductive housing structures 12W (e.g., across the width of device 10, parallel to the X-axis). Ground structures GND may include one or more conductive layers such as a conductive support plate running along a dielectric (e.g., glass) cover layer that forms rear housing wall 12R of device 10 (FIG. 1), conductive portions of display 14 (FIG. 1) of device 10 opposite the rear wall, and/or a conductive mid-chassis that is vertically interposed between display 14 and the conductive support plate. The conductive support plate may be replaced by a conductive lower chassis that is not coupled to the dielectric cover layer if desired. Two or more of these structures may be formed from the same integral piece of metal as segments S6 and S3 of peripheral conductive housing structures 12W if desired. Conductive interconnect structures (e.g., conductive springs, conductive clips, conductive foam, conductive adhesive, conductive pins, conductive screws, conductive brackets, conductive tabs, solder, welds, etc.) may couple each of these structures together to form ground structures GND. Ground structures GND may be held at a ground potential or other reference potential and may form part of the antenna ground for the antennas 40 in device 10.

As shown in FIG. 3, device 10 may include multiple slots L between ground structures GND and peripheral conductive housing structures 12W. For example, device 10 may include an upper slot such as slot L1 in upper region 20 and a lower slot such as slot L2 in lower region 22. The lower edge of slot L1 may be defined by upper edge E1 of ground structures GND. The upper edge of slot L1 may be defined by segments S1 and S2 (e.g., slot L1 may be interposed between ground structures GND and segments S1 and S2 of peripheral conductive housing structures 12W). The upper edge of slot L2 may be defined by lower edge E2 of ground structures GND. The lower edge of slot L2 may be defined by segments S5 and S4 (e.g., slot L2 may be interposed between ground structures GND and segments S5 and S4 of peripheral conductive housing structures 12W).

Slot L1 may have an elongated shape extending from a first end at gap 18-2 to an opposing second end at gap 18-3 (e.g., slot L1 may span the width of device 10). Similarly, slot L2 may have an elongated shape extending from a first end at gap 18-6 to an opposing second end at gap 18-4 (e.g., slot L2 may span the width of device 10). Slots L1 and L2 may be filled with air, plastic, glass, sapphire, epoxy, ceramic, or other dielectric material. Slot L1 may be continuous with gaps 18-1, 18-2, and 18-3 in peripheral conductive housing structures 12W if desired (e.g., a single piece of dielectric material may be used to fill both slot L1 and gaps 18-1, 18-2, and 18-3). Similarly, slot L2 may be continuous with gaps 18-6, 18-5, and 18-4 if desired (e.g., a single piece of dielectric material may be used to fill both slot L2 and gaps 18-6, 18-5, and 18-4).

In implementations that are described herein as an example, device 10 may include at least nine antennas 40 at different locations on device 10 such as at least antennas 40-1, 40-2, 40-3, 40-4, 40-5, 40-6, 40-7, 40-8, and 40-9. This is illustrative and non-limiting. In general, device 10 may include any desired number of antennas 40 (e.g., more than nine antennas or fewer than nine antennas). Ground structures GND, segment S1, segment S2, and portions of slot L1 may be used in forming multiple antennas 40 in upper region 20 of device 10 (sometimes referred to herein as upper antennas) such as antennas 40-2, 40-4, 40-8, and/or 40-5. As one example, antenna 40-2 may have a resonating element arm formed from segment S1 and an antenna feed coupled between segment S1 and ground structures GND, antenna 40-4 may have a resonating element arm formed from segment S2 and an antenna feed coupled between segment S2 and ground structures GND, antenna 40-8 may have an antenna resonating element formed from a portion of slot L1 (e.g., between segment S6 and ground structures GND) or from conductive traces on a flexible printed circuit overlapping or adjacent the volume of antenna 40-2, and antenna 40-5 may have an antenna resonating element formed from a portion of slot L1 (e.g., between segment S3 and ground structures GND) or from conductive traces on a flexible printed circuit overlapping or adjacent the volume of antenna 40-4.

On the other hand, ground structures GND, portions of slot L2, segment S5, and segment S4 may be used in forming multiple antennas 40 in lower region 22 of device 10 (sometimes referred to herein as lower antennas) such as antennas 40-1, 40-3, 40-7, and 40-9. As one example, antenna 40-3 may have a resonating element arm formed from segment S5 and an antenna feed coupled between segment S5 and ground structures GND, antenna 40-1 may have a resonating element arm formed from segment S4 and an antenna feed coupled between segment S4 and ground structures GND, antenna 40-7 may have an antenna resonating element formed from a portion of slot L2 (e.g., between segment S6 and ground structures GND) or from conductive traces on a flexible printed circuit overlapping or adjacent the volume of antenna 40-3, and antenna 40-9 may have an antenna resonating element formed from a portion of slot L2 (e.g., between segment S3 and ground structures GND) or from conductive traces on a flexible printed circuit overlapping or adjacent the volume of antenna 40-1.

This example is illustrative and non-limiting. If desired, one or more of these antennas or other antennas 40 may be located between regions 20 and 22. Region 20 may include any desired number of zero, one, or more than one antenna 40. Region 22 may include any desired number of zero, one, or more than one antenna 40. If desired, one or more phased antenna arrays for conveying millimeter and centimeter wave signals may at least partially overlap slot L1, ground structures GND, and/or slot L2 (not shown in FIG. 3 for the sake of clarity). The phased antenna arrays may radiate through display 14 (FIG. 1), through rear housing wall 12R (FIG. 1), and/or through one or more apertures in peripheral conductive housing structures 12W. Device 10 may have other form factors (e.g., a non-rectangular housing having any desired number of straight and/or curved sides).

Each of antennas 40-1 through 40-9 may convey radio-frequency signals in different combinations of one or more frequency bands. For example, antennas 40-1 through 40-9 may collectively convey radio-frequency signals in different combinations of frequency bands including WLAN bands, WPAN bands, satellite navigation bands, and cellular bands such as one or more low bands LB, low-midbands LMB, midbands MB, high bands HB, ultra-high bands UHB, etc. Different ones of antennas 40-1 through 40-9 may cover any desired combination of one or more of these bands.

If desired, the transceivers 44 in wireless circuitry 38 (FIG. 1) may include one or more feedback receivers (FRX). When radio-frequency signals are transmitted over antenna(s) 40 via RFFE circuitry 48, one or more RF couplers in RFFE circuitry 48 may couple or tap the transmitted radio-frequency signals off corresponding radio-frequency transmission line path(s) 46 and towards the FRX over one or more feedback paths. The FRX may measure the coupled radio-frequency signals to monitor the transmit power and/or other parameters of wireless circuitry 38. The FRX may be used to adjust one or more power amplifiers in RFFE circuitry 48 based on the measured transmit power to ensure that wireless circuitry 38 continues to transmit radio-frequency signals at the desired transmit power level (e.g., using a closed-loop power adjustment scheme) and/or to ensure that wireless circuitry 38 complies with regulatory limits on radio-frequency energy exposure (e.g., specific absorption rate (SAR) limits and/or maximum permissible exposure (MPE) limits).

If desired, the FRX may also perform other measurements based on the radio-frequency signals fed back to the FRX from the RF coupler(s) such as impedance measurements (e.g., complex scattering parameter values such as S-parameter values, reflection coefficients, etc.), voltage standing wave ratio (VSWR) measurements, or other measurements. These measurements may be used to detect when an external object is in the vicinity of the corresponding antenna(s) (e.g., to know when regulatory limits on radio-frequency energy exposure are implicated). The measurements may also be used to adjust tuning circuitry and/or impedance matching circuitry in antenna(s) 40 and/or RFFE circuitry 48 to ensure that the antenna(s) continue to exhibit maximum efficiency under different impedance loading conditions from external objects in the vicinity of device 10.

The RF couplers in RFFE circuitry 48 may, for example, include one or more directional couplers (e.g., switch couplers). A directional coupler includes one or more transmission line structures, transformers, or other signal coupling structures that are disposed on a signal path of a corresponding radio-frequency transmission line 46 and that couple some of the radio-frequency signals transmitted over the signal path off of the signal path. The directional coupler may include one or more ports or nodes such as an isolated node and a coupled node. One or more of the nodes may be coupled to ground via a corresponding impedance termination. The impedance termination(s) may be adjustable if desired. One or more of the nodes may be coupled to switching circuitry (e.g., one or more switches) that couples the directional coupler to the FRX over a feedback path. The switching circuitry may be adjusted to provide the FRX with either forward wave signals (e.g., signals transmitted over the signal path in a forward direction towards the corresponding antenna) or reverse wave signals (e.g., the transmitted signals that have reflected off the antenna and back onto the signal path in a reverse direction due to an impedance discontinuity between the antenna and the signal path). The FRX may measure the forward and reverse wave signals and control circuitry 28 may generate impedance measurements, S-parameter values, reflection coefficients, VSWR values, or any other desired wireless performance metric data from the forward/reverse wave signals and/or other signal measurements performed by the FRX. The RF coupler(s) in RFFE circuitry 48 may sometimes also be referred to herein as signal couplers or RF signal couplers.

In some scenarios, the RF couplers in RFFE circuitry 48 are integrated into dedicated RF coupler modules (e.g., RFFE modules in RFFE circuitry 48 that only include the RF couplers) that are disposed between filter circuitry in RFFE circuitry 48 and antenna(s) 40. However, dedicated RF coupler modules disposed between the filter circuitry and the antenna(s) can be expensive to manufacture, consume an excessive amount of space in RFFE circuitry 48, exhibit poor isolation that requires additional filters on the feedback path(s), and increase the complexity of the controller(s) for RFFE circuitry 48. To mitigate these issues, the RF couplers may be integrated into other RFFE modules in RFFE circuitry 48 (e.g., RFFE modules that are not dedicated to RF couplers) such as power amplifier modules in RFFE circuitry 48. RF couplers that are integrated into other modules of RFFE circuitry 48 such as power amplifier modules may sometimes be referred to herein as integrated RF couplers or integrated signal couplers.

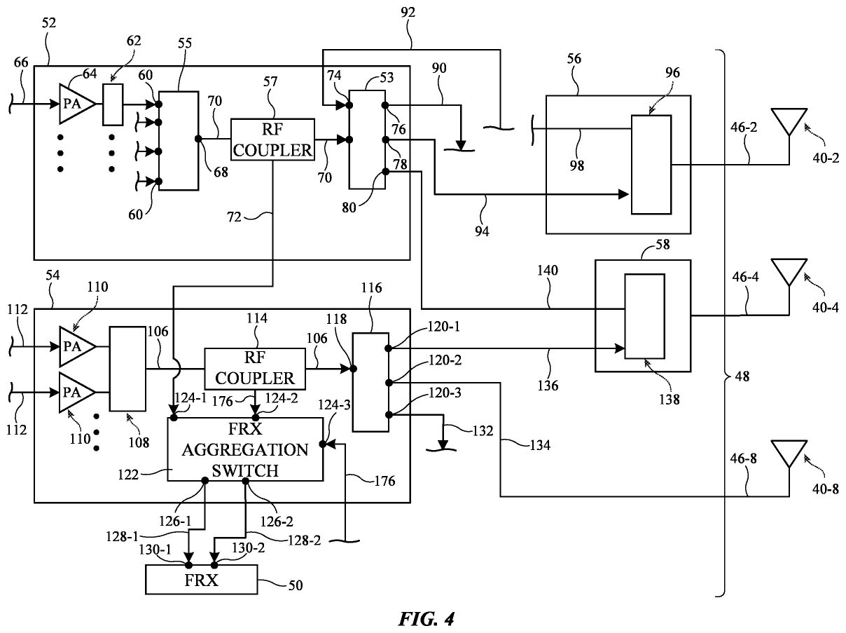

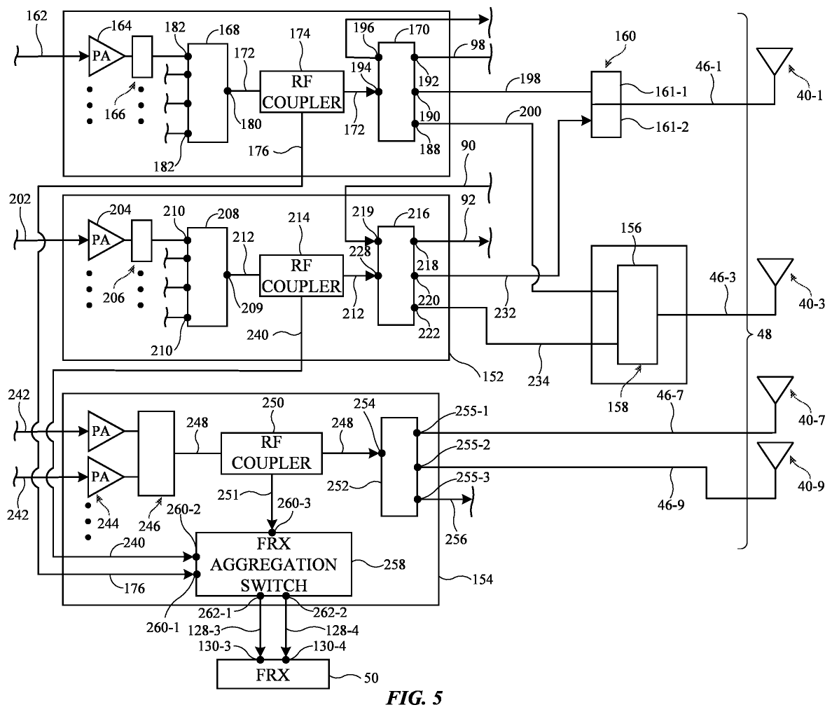

FIGS. 4 and 5 are circuit diagrams showing one example of how RFFE circuitry 48 may include RF couplers integrated into power amplifier modules. In the example of FIGS. 4 and 5, RFFE circuitry 48 couples one or more transceivers 44 (FIG. 1) to at least seven antennas 40-1, 40-2, 40-3, 40-4, 40-7, 40-8, and 40-9 (e.g., located at ends 20 and 22 as shown in FIG. 3). This is illustrative and non-limiting. In general, antennas 40-1, 40-2, 40-3, 40-4, 40-7, 40-8, and 40-9 of FIGS. 4 and 5 may be any antennas at any desired locations in device 10 and/or may cover any desired frequency bands. RFFE circuitry 48 may couple one or more transceivers 44 to any desired number of two or more antennas 40.

Antenna 40-1 may be coupled to the one or more transceivers 44 over a corresponding radio-frequency transmission line path 46-1, antenna 40-2 may be coupled to the one or more transceivers 44 over a corresponding radio-frequency transmission line path 46-2, antenna 40-3 may be coupled to the one or more transceivers 44 over a corresponding radio-frequency transmission line path 46-3, antenna 40-4 may be coupled to the one or more transceivers 44 over a corresponding radio-frequency transmission line path 46-4, antenna 40-7 may be coupled to the one or more transceivers 44 over a corresponding radio-frequency transmission line path 46-7, antenna 40-8 may be coupled to the one or more transceivers 44 over a corresponding radio-frequency transmission line path 46-8, and antenna 40-9 may be coupled to the one or more transceivers 44 over a corresponding radio-frequency transmission line path 46-9.

RFFE circuitry 48 may be disposed on radio-frequency transmission line paths 46-1, 46-2, 46-3, 46-4, 46-7, 46-8, and 46-9 between the one or more transceivers 44 and antennas 40-1, 40-2, 40-3, 40-4, 40-7, 40-8, and 40-9. RFFE circuitry 48 may include signal paths (e.g., transmission lines) on one or more RFFE modules and/or external to the RFFE modules (e.g., coupling different RFFE modules together, coupling the RFFE modules to one or more of the antennas, coupling the RFFE modules to the one or more transceivers 44, and/or coupling the one or more transceivers 44 one or more of the antennas without passing through an RFFE module, etc.). The transmission lines may form part of radio-frequency transmission line paths 46-1, 46-2, 46-3, 46-4, 46-7, 46-8, and/or 46-9.

As shown in FIGS. 4 and 5, RFFE circuitry 48 may be coupled to a feedback receiver such as FRX 50 over one or more feedback paths 128 (e.g., a first feedback path 128-1, a second feedback path 128-2, a third feedback path 128-3, a fourth feedback path 128-4, etc.). Each feedback path 128 may be coupled to a different respective input port 130 of FRX 50 (e.g., feedback path 128-1 may be coupled to input port 130-1 of FRX 50, feedback path 128-2 may be coupled to input port 130-2 of FRX 50, feedback path 128-3 may be coupled to input port 130-3 of FRX 50, feedback path 128-4 may be coupled to input port 130-4 of FRX 50, etc.). FRX 50 may be formed from a dedicated transceiver 44 (FIG. 1) that is used in measuring signals conveyed over radio-frequency transmission line path(s) 46 or may be integrated within one or more of the transceivers 44 used to transmit and/or receive radio-frequency signals over radio-frequency transmission line path(s) 46 (e.g., one or more transceivers 44 may be provided with feedback receiver functionality that operates on signals received over input ports 130).

As shown in FIGS. 4 and 5, RFFE circuitry 48 may include at least five RFFE modules having power amplifiers (sometimes referred to herein as power amplifier (PA) modules) such as PA modules 52, 54, 150, 152, and 154. Each of PA modules 52, 54, 150, 152, and 154 may include radio-frequency components mounted to a different respective substrate. RFFE circuitry 48 may also include at least three RFFE modules having filter circuitry (sometimes referred to herein as filter modules) such as filter modules 56, 58, and 156. Each of filter modules 56, 58, and 156 may include radio-frequency components mounted to a different respective substrate. This example is illustrative and non-limiting. In general, RFFE circuitry 48 may include any desired number of one or more PA modules, any desired number of one or more filter modules, and/or the filter circuitry in the filter modules may be integrated into the PA modules.

In the example of FIGS. 4 and 5, antennas 40-1, 40-2, 40-3, 40-4, 40-7, 40-8, and 40-9 collectively cover at least seven different groups or sets of frequency bands such as low bands LB, low-midbands LMB, midbands MB, high bands HB, ultra-high bands UHB, and WLAN bands, and a satellite navigation band. This is illustrative and non-limiting. In general, the antennas may collectively cover any desired number of any desired frequency bands at any desired frequencies. The number of PA modules and filter modules may vary depending on the number of antennas, the location of the antennas, and the number of frequency bands to be conveyed via RFFE circuitry 48.

For example, the portion of RFFE circuitry 48 shown in FIG. 4 may be used to convey radio-frequency signals using upper antennas at the upper end 20 of device 10 (FIG. 5) such as antennas 40-2, 40-4, and 40-5. PA module 52 may include power amplifiers that transmit and amplify radio-frequency signals in high bands HB whereas PA module 54 includes power amplifiers that transmit and amplify radio-frequency signals in ultra-high bands UHB. If desired, this portion of RFFE circuitry 48 may be disposed within device 10 at, overlapping, or adjacent to upper end 20 of device 10 to minimize loss.

On the other hand, the portion of RFFE circuitry 48 shown in FIG. 5 may be used to convey radio-frequency signals using lower antennas at the lower end 22 of device 10 (FIG. 5) such as antennas 40-1, 40-3, 40-7, and 40-9. PA module 150 may include power amplifiers that transmit and amplify radio-frequency signals in low bands LB, whereas PA module 152 includes power amplifiers that transmit and amplify radio-frequency signals in high bands HB and PA module 154 includes power amplifiers that transmit and amplify radio-frequency signals in ultra-high bands UHB. If desired, this portion of RFFE circuitry 48 may be disposed within device 10 at, overlapping, or adjacent to lower end 22 of device 10 to minimize loss. This is illustrative and non-limiting and, in general, the antennas may be located anywhere in device 10, the components of RFFE circuitry 48 may be disposed anywhere in device 10, and the PA modules may be used to transmit and amplify radio-frequency signals in any desired frequency bands.

As shown in FIG. 4, PA module 52 may include a first switch such as band selection switch 55 and a second switch such as antenna selection switch 53 disposed on the signal path (transmit chain) between the transceiver(s) and antenna(s). Band selection switch 55 may have an output terminal 68. Antenna selection switch 53 may have an input terminal 59 coupled to output terminal 68 of band selection switch 55 over signal path 70 (e.g., a transmission line).

Band selection switch 55 may have one or more input terminals 60. Each input terminal 60 may be coupled to transceiver 44 over a corresponding signal path 66. Each signal path 66 may be coupled to a different respective port of the transceiver, for example. The transceiver may transmit radio-frequency signals over each of the ports and thus over each signal path 66 in a different respective high band HB (or any other desired frequency bands). PA module 52 may include a respective PA 64 and filter 62 (e.g., a duplexer) disposed on each signal path 66. Each PA 64 may amplify the radio-frequency signals transmitted by transceiver 44 over its corresponding signal path 66. PA module 52 may sometimes also be referred to herein as high band diversity switch module (DSM) 52.

Band selection switch 55 may be switchable between a number of different switch states. In each switch state, band selection switch 55 may couple a different one of its input terminals 60 to its output terminal 68 and thus to signal path 70. Control circuitry 28 (FIG. 1) may adjust the state of band selection switch 55 to route radio-frequency signals in a selected one of the high bands HB onto signal path 70 (e.g., band selection switch 55 may be adjusted to switch the frequency or band of the radio-frequency signals transmitted onto signal path 70).

Whereas band selection switch 55 selects the frequency band of the radio-frequency signals transmitted onto signal path 70, antenna selection switch 53 may select the antenna that is used to transmit the radio-frequency signals on signal path 70. For example, antenna selection switch 53 may have a first terminal 78 communicatively coupled to antenna 40-2 via signal path 94 and filter module 56 and may have a second terminal 80 communicatively coupled to antenna 40-4 via signal path 140 and filter module 58. Antenna selection switch 53 may also have a terminal 76 communicatively coupled to one or more of the lower antennas via signal path 90 and PA module 152 (FIG. 5). If desired, antenna selection switch 53 may also have a terminal 74 coupled to PA module 152 (FIG. 5) over signal path 92. Antenna selection switch 53 may receive radio-frequency signals from PA module 152 via signal path 92 for transmission over antennas 40-2 or 40-4, for example.

Once band selection switch 55 has selected the frequency band of the radio-frequency signals on signal path 70, control circuitry 28 (FIG. 1) may control antenna selection switch 53 to route the radio-frequency signals on signal path 70 to a selected antenna 40. For example, when antenna selection switch 53 is placed in a first switch state where input terminal 59 is coupled to terminal 78, PA module 52 may transmit the radio-frequency signals on signal path 70 over signal path 94, filter module 56, and antenna 40-2. When antenna selection switch 53 is placed in a second switch state where input terminal 59 is coupled to terminal 80, PA module 52 may transmit the radio-frequency signals on signal path 70 over signal path 140, filter module 58, and antenna 40-4. When antenna selection switch 53 is placed in a third switch state where input terminal 59 is coupled to terminal 90, PA module 52 may transmit the radio-frequency signals on signal path 70 over signal path 90 to an antenna selection switch in PA module 152 (FIG. 5), which routes the radio-frequency signals to one of the lower antennas.

When antenna selection switch 53 is placed in a fourth switch state where terminal 74 is coupled to terminal 78, PA module 52 may transmit radio-frequency signals received from PA module 152 (FIG. 5) over signal path 94, filter module 56, and antenna 40-2. When antenna selection switch 53 is placed in a fifth switch state where terminal 74 is coupled to terminal 80, PA module 52 may transmit radio-frequency signals received from PA module 152 (FIG. 5) over signal path 140, filter module 58, and antenna 40-4.

These examples are illustrative and non-limiting. In general, antenna selection switch 53 may have any desired number of switch states. If desired, antenna selection switch 53 may concurrently couple different terminals together to concurrently route radio-frequency signals from radio-frequency signal path 70 and/or from signal path 92 onto different antennas 40 for transmission. Antenna selection switch 53 may have fewer than five terminals or more than five terminals. By controlling the state of band selection switch 55 and antenna selection switch 53, the control circuitry may control the frequency band and antenna(s) over which radio-frequency signals are transmitted in a high band HB.

As shown in FIG. 4, PA module 54 may include a duplexer 108 and an antenna selection switch 116 disposed on the signal path (transmit chain) between the transceiver(s) and antenna(s). Antenna selection switch 116 may have an input terminal 118 coupled to the output of duplexer 108 over signal path 106 (e.g., a transmission line). Duplexer 108 may have inputs each coupled to transceiver 44 over a different respective signal path 112. Each signal path 112 may be coupled to a different respective port of the transceiver. The transceiver may transmit radio-frequency signals over each of the ports and thus over each signal path 112 in a different respective ultra-high band UHB (or any other desired frequency bands).

PA module 54 may include a respective PA 110 disposed on each signal path 112. Each PA 110 may amplify the radio-frequency signals transmitted by transceiver 44 over its corresponding signal path 112. Duplexer 108 may, for example, pass signals in different UHBs from any desired number of signal paths 112 onto signal path 106. PA module 54 may sometimes also be referred to herein as UHB switch power amplifier duplexer (SPAD) module 54.

Antenna selection switch 116 may have output terminals 120 coupled to different antennas 40 in device 10. For example, antenna selection switch 116 may have a first output terminal 120-1 communicatively coupled to antenna 40-4 via filter module 58 and signal path 136, a second output terminal 120-2 communicatively coupled to antenna 40-8 over signal path 134, and a third output terminal 120-3 communicatively coupled to a lower antenna over signal path 132.

Control circuitry 28 (FIG. 1) may control antenna selection switch 116 to route the radio-frequency signals on signal path 106 to a selected antenna 40. For example, when antenna selection switch 116 is placed in a first switch state where input terminal 118 is coupled to output terminal 120-1. PA module 54 may transmit the radio-frequency signals on signal path 106 over signal path 136, filter module 58, and antenna 40-4. When antenna selection switch 116 is placed in a second switch state where input terminal 118 is coupled to output terminal 120-2, PA module 54 may transmit the radio-frequency signals on signal path 106 over signal path 134 and antenna 40-8. When antenna selection switch 116 is placed in a third switch state where input terminal 118 is coupled to output terminal 120-3, PA module 54 may transmit the radio-frequency signals on signal path 70 over signal path 132 and a lower antenna.

These examples are illustrative and non-limiting. In general, antenna selection switch 116 may have any desired number of switch states. If desired, antenna selection switch 116 may concurrently couple different terminals together to concurrently route radio-frequency signals from radio-frequency signal path 106 onto different antennas 40 for transmission. Antenna selection switch 116 may have fewer than four terminals or more than four terminals. By controlling the state of antenna selection switch 116, the control circuitry may control the antenna(s) over which radio-frequency signals are transmitted in an ultra-high UHB.

Filter module 56 may include any desired filter circuitry and/or other radio-frequency components. As one example, filter module 56 may include a filter such as filter 96. Filter 96 may be a diplexer or a triplexer, as two examples. Filter 96 may have at least a first input coupled to signal path 98, a second input coupled to signal path 94, and an output coupled to antenna 40-2. Signal path 98 may, for example, be coupled to PA module 150 of FIG. 5.

Filter 96 may pass radio-frequency signals in a first frequency band or group of frequency bands (e.g., cellular low bands LB) between signal path 98 and antenna 40-2 (e.g., radio-frequency signals transmitted by PA module 150 of FIG. 5). Filter 96 may pass radio-frequency signals in a second frequency band or group of frequency bands (e.g., high band HBs, low-midband LMBs, and/or midbands MB) from signal path 94 onto antenna 40-2. In this way, filter module 56 may concurrently route different radio-frequency signals to or from antenna 40-2 in different frequency bands while allowing the radio-frequency signals to remain isolated from each other (e.g., to prevent interference between the different frequencies at the transceiver(s)).

Similarly, filter module 58 may include any desired filter circuitry and/or other radio-frequency components. As one example, filter module 58 may include a filter such as filter 138. Filter 138 may include a diplexer, a triplexer, adjustable circuitry, a switchplexer, and/or any other desired filter circuitry. The adjustable circuitry (not shown for the sake of clarity) may include switching circuitry, matching circuitry, or antenna tuning components that serve to adjust the frequency response (e.g., cutoff frequencies and/or characteristics) of filter 138.

For example, filter 138 may have a first input coupled to signal path 140, a second input coupled to signal path 136, and an output coupled to antenna 40-4. Filter 138 may pass radio-frequency signals in third and/or fourth frequency bands or groups of frequency bands (e.g., midbands MB, high bands HB, and/or an S-band) between signal path 140 and antenna 40-4. If desired, the adjustable circuitry in filter 138 may be adjusted to tune one or more of the cutoff frequencies of the filter. Filter 138 may pass radio-frequency signals in a fifth frequency band or group of frequency bands (e.g., ultra-high bands UHB) between signal path 136 and antenna 40-4. In this way, filter module 58 may concurrently route different radio-frequency signals to or from antenna 40-4 in different frequency bands while allowing the radio-frequency signals to remain isolated from each other (e.g., to prevent interference between the different frequencies at the transceiver(s)).

In some scenarios, RFFE circuitry 48 includes RF couplers disposed on dedicated RFFE modules between filter modules 56 and 58 and antennas 40-2 and 40-4. RF couplers for coupling signals in different bands may be disposed on the same RFFE module. To greatly reduce the design complexity and space consumption on device 10 while maximizing isolation between the different frequency bands, the RF couplers may instead be integrated into PA modules 52 and 54. PA module 54 may include an FRX aggregation switch 122 that couples the feedback paths from one or more RF couplers in RFFE circuitry 48 to FRX 50. The example of FIG. 4 in which PA module 54 includes FRX aggregation switch 122 is illustrative and, if desired, FRX aggregation switch 122 may be disposed on PA module 52 instead of PA module 54 or on one of the PA modules at lower end 22 of device 10 (FIG. 5).

FRX aggregation switch 122 may have a set of one or more input terminals 124. Each input terminal 124 may be coupled to a different RF coupler in RFFE circuitry 48 over a respective feedback path (e.g., from different PA modules of RFFE circuitry 48). FRX aggregation switch 122 may have a set of one or more output terminals 126. Each output terminal 126 may be coupled to a different respective input port 130 of FRX 50 over a corresponding feedback path 128. For example, FRX 50 may have a first input port 130-1 coupled to output terminal 126-1 of FRX aggregation switch 122 over feedback path 128-1 and may have a second input port 130-2 coupled to output terminal 126-2 of FRX aggregation switch 122 over feedback path 128-2.

As shown in FIG. 4, PA module 52 may include an RF coupler 57 disposed on signal path 70 between band selection switch 55 and antenna selection switch 53. RF coupler 57 may be, for example, a directional coupler having switching circuitry coupled to input terminal 124-1 of FRX aggregation switch 122 over feedback path 72. Similarly, PA module 54 may include an RF coupler 114 disposed on signal path 106 between duplexer 108 and antenna selection switch 116. RF coupler 114 may be, for example, a directional coupler having switching circuitry coupled to input terminal 124-2 of FRX aggregation switch 122 over feedback path 115. If desired, FRX aggregation switch 122 may have an additional input terminal 124-3 coupled to PA module 150 (FIG. 5) over feedback path 176.

When PA module 52 transmits radio-frequency signals over signal path 70, RF coupler 57 may couple some of the radio-frequency signals off of signal path 70 (e.g., in the forward and/or reverse directions) and onto feedback path 72. Feedback path 72 may pass the coupled radio-frequency signals to FRX aggregation switch 122. In this way, FRX aggregation switch 122 may receive coupled signals from an RF coupler external to its own RFFE module (e.g., from RF coupler 57, which is external to PA module 54 because RF coupler 57 is disposed on PA module 52). When PA module 54 transmits radio-frequency signals over signal path 106, RF coupler 114 may couple some of the radio-frequency signals off of signal path 106 (e.g., in the forward and/or reverse directions) and onto feedback path 115. When PA module 150 (FIG. 5) transmits radio-frequency signals, the RF coupler on PA module 150 may couple some of the radio-frequency signals onto feedback path 176, which conveys the coupled signals to FRX aggregation switch 122.

FRX aggregation switch 122 may select which of the coupled radio-frequency signals are provided to FRX 50. FRX aggregation switch 122 may have different switch states in which different input terminal(s) 124 are coupled to different output terminal(s) 126. For example, FRX aggregation switch 122 may couple input terminal 124-1 to output terminal 126-1 to pass the radio-frequency signals coupled off signal path 70 by RF coupler 57 to FRX 50 for further processing (e.g., for measuring the transmit power level of a PA 64 on PA module 52, for measuring the impedance of antenna 40-2 and/or antenna 40-4 in high band HB, etc.). Similarly, FRX aggregation switch 122 may couple input terminal 124-2 to output terminal 126-1 to pass the radio-frequency signals coupled off signal path 106 by RF coupler 114 to FRX 50 for further processing (e.g., for measuring the transmit power level of a PA 110 on PA module 52, for measuring the impedance of antenna 40-4 and/or antenna 40-8 in an ultra-high band UHB, etc.). Further, FRX aggregation switch 122 may couple input terminal 124-3 to output terminal 126-1 to pass the radio-frequency signals received over feedback path 176 to FRX 50 for further processing (e.g., for measuring the transmit power level of a PA on PA module 150 of FIG. 5, for measuring the impedance of antenna 40-1, antenna 40-2, and/or antenna 40-3 in a low band LB, etc.).

If desired, FRX aggregation switch 122 may use output terminals 126-1 and 126-2 and feedback paths 128-1 and 128-2 to concurrently convey radio-frequency signals received over any two of feedback paths 72, 115, and 176 to FRX 50 (e.g., FRX aggregation switch 122 may have one or more switch states in which two input terminals 124 are coupled to output terminals 126-1 and 126-2, respectively). This may, for example, allow FRX 50 to concurrently measure the transmit power level of more than one PA module and/or to concurrently measure the impedance of two or more antennas in one or more frequency bands. If desired, FRX aggregation switch 122 may have more than two output terminals 126 coupled to more than two input ports 130 of FRX 50 over respective feedback paths 128 and may concurrently route radio-frequency signals from two or more RF couplers to FRX 50. If desired, FRX aggregation switch 122 may have a single output terminal 126 coupled to a single input port 130 of FRX 50 over a corresponding feedback path 128.

As shown in FIG. 5 (e.g., at the lower end of device 10), PA module 150 may include a first switch such as band selection switch 168 and a second switch such as antenna selection switch 170 disposed on the signal path (transmit chain) between the transceiver(s) and antenna(s). Band selection switch 168 may have an output terminal 180. Antenna selection switch 170 may have an input terminal 194 coupled to output terminal 180 of band selection switch 168 over signal path 172 (e.g., a transmission line).

Band selection switch 168 may have one or more input terminals 182. Each input terminal 182 may be coupled to a corresponding transceiver port over a respective signal path 162. The transceiver may transmit radio-frequency signals over each of the ports and thus over each signal path 162 in a different respective low band LB (or any other desired frequency bands). PA module 150 may include a respective PA 164 and filter 166 (e.g., a duplexer) disposed on each signal path 162. Each PA 164 may amplify the radio-frequency signals transmitted by the transceiver over its corresponding signal path 162.

Band selection switch 168 may be switchable between a number of different switch states. In each switch state, band selection switch 168 may couple a different one of its input terminals 182 to its output terminal 180 and thus to signal path 172. Control circuitry 28 (FIG. 1) may adjust the state of band selection switch 168 to route radio-frequency signals in a selected one of the high bands HB onto signal path 172 (e.g., band selection switch 168 may be adjusted to switch the frequency or band of the radio-frequency signals transmitted onto signal path 172).

Whereas band selection switch 168 selects the frequency band of the radio-frequency signals transmitted onto signal path 172, antenna selection switch 170 may select the antenna that is used to transmit the radio-frequency signals on signal path 172. For example, antenna selection switch 170 may have a first terminal 190 communicatively coupled to antenna 40-1 via signal path 198 and a filter such as duplexer 160. Antenna selection switch 170 may have a second terminal 188 communicatively coupled to antenna 40-3 via signal path 200 and filter module 156. Antenna selection switch 170 may also have a terminal 192 communicatively coupled to antenna 40-2 over filter module 56 (FIG. 4) and signal path 98, and a terminal 196 coupled to another RFFE module (not shown) or elsewhere in the RFFE circuitry.

Once band selection switch 168 has selected the frequency band of the radio-frequency signals on signal path 172, control circuitry 28 (FIG. 1) may control antenna selection switch 170 to route the radio-frequency signals on signal path 172 to a selected antenna 40. For example, when antenna selection switch 170 is placed in a first switch state where input terminal 194 is coupled to terminal 190, PA module 150 may transmit the radio-frequency signals on signal path 172 over signal path 198, duplexer 160, and antenna 40-1. When antenna selection switch 170 is placed in a second switch state where input terminal 194 is coupled to terminal 188, PA module 150 may transmit the radio-frequency signals on signal path 172 over signal path 200, filter module 156, and antenna 40-3.

When antenna selection switch 170 is placed in a third switch state where input terminal 194 is coupled to terminal 192, PA module 150 may transmit the radio-frequency signals on signal path 172 over signal path 98 to filter module 56 for transmission over antenna 40-2 (FIG. 4). When antenna selection switch 170 is placed in a fourth switch state where terminal 196 is coupled to terminal 190, PA module 150 may transmit radio-frequency signals received from elsewhere via terminal 196 over antenna 40-1. When antenna selection switch 170 is placed in a fifth switch state where terminal 196 is coupled to terminal 188, PA module 150 may transmit radio-frequency signals received from elsewhere via terminal 196 over antenna 40-3. Antenna selection switch 170 may be placed in additional switch states in which terminals 196 and/or 194 are coupled to any other desired terminals for transmitting radio-frequency signals in a low band LB over one or more selected antennas 40.

These examples are illustrative and non-limiting. In general, antenna selection switch 170 may have any desired number of switch states. If desired, antenna selection switch 170 may concurrently couple different terminals together to concurrently route radio-frequency signals from radio-frequency signal path 172 and/or from terminal 196 onto different antennas 40 for transmission. Antenna selection switch 170 may have fewer than six terminals or more than six terminals. By controlling the state of band selection switch 168 and antenna selection switch 170, the control circuitry may control the frequency band and antenna(s) over which radio-frequency signals are transmitted in a low band LB.

PA module 152 may include a first switch such as band selection switch 208 and a second switch such as antenna selection switch 216 disposed on the signal path (transmit chain) between the transceiver(s) and antenna(s). Band selection switch 208 may have an output terminal 209. Antenna selection switch 216 may have an input terminal 228 coupled to output terminal 209 of band selection switch 208 over signal path 212 (e.g., a transmission line).

Band selection switch 208 may have one or more input terminals 210. Each input terminal 210 may be coupled to transceiver 44 over a corresponding signal path 202. Each signal path 202 may be coupled to a different respective port of the transceiver. The transceiver may transmit radio-frequency signals over each of the ports and thus over each signal path 202 in a different respective high band HB (or any other desired frequency bands). PA module 152 may include a respective PA 204 and filter 206 (e.g., a duplexer) disposed on each signal path 202. Each PA 204 may amplify the radio-frequency signals transmitted by transceiver 44 over its corresponding signal path 202. PA module 152 may sometimes also be referred to herein as HB SPAD 152.

Band selection switch 208 may be switchable between a number of different switch states. In each switch state, band selection switch 208 may couple a different one of its input terminals 210 to its output terminal 209 and thus to signal path 212. Control circuitry 28 (FIG. 1) may adjust the state of band selection switch 208 to route radio-frequency signals in a selected one of the high bands HB onto signal path 212 (e.g., band selection switch 208 may be adjusted to switch the frequency or band of the radio-frequency signals transmitted onto signal path 212).

Whereas band selection switch 208 selects the frequency band of the radio-frequency signals transmitted onto signal path 212, antenna selection switch 216 may select the antenna that is used to transmit the radio-frequency signals on signal path 212. For example, antenna selection switch 216 may have a first terminal 220 communicatively coupled to antenna 40-1 via signal path 232 and duplexer 160. Antenna selection switch 216 may have a second terminal 222 communicatively coupled to antenna 40-3 via signal path 234 and filter module 156.

Antenna selection switch 216 may also have a terminal 218 communicatively coupled to one or more of the upper antennas via signal path 92 and PA module 52 (FIG. 4). If desired, antenna selection switch 216 may also include a terminal 219 coupled to PA module 150 (FIG. 4) over signal path 90. Antenna selection switch 216 may receive radio-frequency signals from PA module 52 over signal path 90 for transmission over antennas 40-1 or 40-3, for example.

Once band selection switch 208 has selected the frequency band of the radio-frequency signals on signal path 212, control circuitry 28 (FIG. 1) may control antenna selection switch 216 to route the radio-frequency signals on signal path 212 to a selected antenna 40. For example, when antenna selection switch 216 is placed in a first switch state where input terminal 228 is coupled to terminal 220, PA module 152 may transmit the radio-frequency signals on signal path 212 over signal path 232, duplexer 160, and antenna 40-1. When antenna selection switch 216 is placed in a second switch state where input terminal 228 is coupled to terminal 222, PA module 152 may transmit the radio-frequency signals on signal path 212 over signal path 234, filter module 156, and antenna 40-3. When antenna selection switch 216 is placed in a third switch state where input terminal 228 is coupled to terminal 218, PA module 152 may transmit the radio-frequency signals on signal path 212 over signal path 92 to terminal 74 of antenna selection switch 53 in PA module 52 (FIG. 4), which routes the radio-frequency signals to one of the upper antennas.

When antenna selection switch 216 is placed in a fourth switch state where terminal 219 is coupled to terminal 220, PA module 152 may transmit radio-frequency signals received from PA module 52 (FIG. 5) over signal path 232, duplexer 160, and antenna 40-1. When antenna selection switch 216 is placed in a fifth switch state where terminal 219 is coupled to terminal 222, PA module 152 may transmit radio-frequency signals received from PA module 52 (FIG. 5) over signal path 234, filter module 156, and antenna 40-3.

These examples are illustrative and non-limiting. In general, antenna selection switch 216 may have any desired number of switch states. If desired, antenna selection switch 216 may concurrently couple different terminals together to concurrently route radio-frequency signals from radio-frequency signal path 212 and/or from signal path 90 onto different antennas 40 for transmission. Antenna selection switch 216 may have fewer than seven terminals or more than seven terminals. By controlling the state of band selection switch 208 and antenna selection switch 216, the control circuitry may control the frequency band and antenna(s) over which radio-frequency signals are transmitted in a high band HB.

PA module 154 may include a filter 246 and an antenna selection switch 252 disposed on the signal path (transmit chain) between the transceiver(s) and antenna(s). Antenna selection switch 252 may have an input terminal 254 coupled to the output of filter 246 over signal path 248 (e.g., a transmission line). Filter 246 may have inputs each coupled to different ports of the transceiver over respective signal paths 242. The transceiver may transmit radio-frequency signals over each of the ports and thus over each signal path 242 in a different respective ultra-high band UHB (or any other desired frequency bands). PA module 154 may include a respective PA 244 disposed on each signal path 242.

Each PA 244 may amplify the radio-frequency signals transmitted by the transceiver over its corresponding signal path 242. Filter 246 may, for example, pass radio-frequency signals in different ultra-high bands (e.g., 5G NR band N77 and band 79) onto signal path 248. Filter 246 may pass signals in different UHBs from any desired number of signal paths 242 onto signal path 248. PA module 154 may sometimes also be referred to herein as UHB SPAD module 154.

Antenna selection switch 252 may have output ports 255 coupled to different antennas 40 in device 10. For example, antenna selection switch 252 may have a first output port 255-1 coupled to antenna 40-7, a second output port 255-2 coupled to antenna 40-9, and a third output port 255-3 communicatively coupled to an upper antenna over signal path 256.

Control circuitry 28 (FIG. 1) may control antenna selection switch 252 to route the radio-frequency signals on signal path 248 to a selected antenna 40. For example, when antenna selection switch 252 is placed in a first switch state where input terminal 254 is coupled to output terminal 255-1. PA module 154 may transmit the radio-frequency signals on signal path 248 over antenna 40-7. When antenna selection switch 252 is placed in a second switch state where input terminal 254 is coupled to output terminal 255-2, PA module 154 may transmit the radio-frequency signals on signal path 248 over antenna 40-9. When antenna selection switch 252 is placed in a third switch state where input terminal 254 is coupled to output terminal 255-3, PA module 154 may transmit the radio-frequency signals on signal path 248 over signal path 256 and an upper antenna.

These examples are illustrative and non-limiting. In general, antenna selection switch 252 may have any desired number of switch states. If desired, antenna selection switch 252 may concurrently couple different terminals together to concurrently route radio-frequency signals from radio-frequency signal path 248 onto different antennas 40 for transmission. Antenna selection switch 252 may have fewer than four terminals or more than four terminals. By controlling the state of antenna selection switch 252, the control circuitry may control the antenna(s) over which radio-frequency signals are transmitted in an ultra-high UHB.

Duplexer 160 may include any desired filter circuitry. Duplexer 160 may have a first input coupled to signal path 198, a second input coupled to signal path 232, and an output coupled to antenna 40-1. Duplexer 160 may include a first filter 161-1 (e.g., a low pass filter) that passes radio-frequency signals in a seventh frequency band or group of frequency bands (e.g., cellular low bands LB) between signal path 198 and antenna 40-1 while blocking other frequencies. Duplexer 160 may include a second filter 161-2 (e.g., a band pass filter) that passes radio-frequency signals in an eighth frequency band or group of frequency bands (e.g., cellular low-midbands LMB, midbands MB, and/or high bands HB) between signal path 232 and antenna 40-1 while blocking other frequencies. In this way, duplexer 160 may concurrently route different radio-frequency signals to or from antenna 40-1 in different frequency bands while allowing the radio-frequency signals to remain isolated from each other (e.g., to prevent interference between the different frequencies at the transceiver(s)).

Similarly, filter module 156 may include any desired filter circuitry and/or other radio-frequency components. As one example, filter module 156 may include a filter such as filter 158. Filter 158 may include a diplexer, a triplexer, a switchplexer, adjustable circuitry (e.g., switching circuitry, matching circuitry, antenna tuning components that serve to adjust the frequency response of filter 158, etc.), and/or any other desired filter circuitry.

For example, filter 158 may have a first input coupled to signal path 200, a second input coupled to signal path 234, and an output coupled to antenna 40-3. Filter 158 may pass radio-frequency signals in a corresponding frequency band or group of frequency bands (e.g., cellular low bands LB) between signal path 200 and antenna 40-3. Filter 158 may pass radio-frequency signals in a corresponding frequency band or group of frequency bands (e.g., cellular midbands MB, cellular high bands HB, and/or an S-band) between signal path 234 and antenna 40-3. In this way, filter module 156 may concurrently route different radio-frequency signals to or from antenna 40-3 in different frequency bands while allowing the radio-frequency signals to remain isolated from each other (e.g., to prevent interference between the different frequencies at the transceiver(s)).

To minimize design complexity and space consumption in device 10 while maximizing isolation between different frequency bands, the RF couplers in RFFE circuitry 48 may be integrated into PA modules 150, 152, and 154. PA module 154 may include an FRX aggregation switch 258 that couples the feedback paths from one or more RF couplers in RFFE circuitry 48 to FRX 50. The example of FIG. 5 in which PA module 154 includes FRX aggregation switch 258 is illustrative and, if desired, FRX aggregation switch 258 may be disposed on PA module 152 or PA module 150 instead of PA module 154 or on one of the PA modules at upper end 20 of device 10 (FIG. 5).

FRX aggregation switch 258 may have a set of one or more input terminals 260. Each input terminal 260 may be coupled to a different RF coupler in RFFE circuitry 48 over a respective feedback path (e.g., from different PA modules of RFFE circuitry 48). FRX aggregation switch 258 may have a set of one or more output terminals 262. Each output terminal 262 may be coupled to a different respective input port 130 of FRX 50 over a corresponding feedback path 128. For example, FRX 50 may have a third input port 130-3 coupled to output port 262-1 of FRX aggregation switch 258 over feedback path 128-3 and may have a fourth input port 130-4 coupled to output terminal 126-2 of FRX aggregation switch 258 over feedback path 128-2.

PA module 150 may include an RF coupler 174 disposed on signal path 172 between band selection switch 168 and antenna selection switch 170. RF coupler 174 may be, for example, a directional coupler having switching circuitry coupled to input terminal 260-1 of FRX aggregation switch 258 over feedback path 176.

Similarly, PA module 152 may include an RF coupler 214 disposed on signal path 212 between band selection switch 208 and antenna selection switch 216. RF coupler 214 may be, for example, a directional coupler having switching circuitry coupled to input terminal 260-2 of FRX aggregation switch 258 over feedback path 240.

PA module 154 may include an RF coupler 250 disposed on signal path 248 between filter 246 and antenna selection switch 252. RF coupler 250 may be, for example, a directional coupler having switching circuitry coupled to input terminal 260-3 of FRX aggregation switch 258 over feedback path 251. If desired, FRX aggregation switch 258 may have additional input terminals and/or output terminals.

When PA module 150 transmits radio-frequency signals over signal path 172, RF coupler 174 may couple some of the radio-frequency signals off of signal path 172 (e.g., in the forward and/or reverse directions) and onto feedback path 176. Feedback path 176 may pass the coupled radio-frequency signals to FRX aggregation switch 258. Additionally or alternatively, feedback path 176 may pass the coupled radio-frequency signals to input terminal 124-3 of FRX aggregation switch 122 on PA module 54 (FIG. 4) if desired.

When PA module 152 transmits radio-frequency signals over signal path 212, RF coupler 214 may couple some of the radio-frequency signals off of signal path 212 (e.g., in the forward and/or reverse directions) and onto feedback path 240. When PA module 154 transmits radio-frequency signals over signal path 248, RF coupler 250 may couple some of the radio-frequency signals off of signal path 248 (e.g., in the forward and/or reverse directions) and onto feedback path 251.

FRX aggregation switch 258 may select which of the coupled radio-frequency signals are provided to FRX 50. FRX aggregation switch 258 may have different switch states in which different input terminal(s) 260 are coupled to different output terminal(s) 262. For example, FRX aggregation switch 258 may couple input terminal 260-1 to output terminal 262-1 to pass the radio-frequency signals coupled off signal path 172 by RF coupler 174 to FRX 50 for further processing (e.g., for measuring the transmit power level of a PA 164 on PA module 150, for measuring the impedance of antenna 40-1 and/or antenna 40-3 in low band LB, etc.).

Similarly, FRX aggregation switch 122 may couple input terminal 260-3 to output terminal 262-1 to pass the radio-frequency signals coupled off signal path 212 by RF coupler 214 to FRX 50 for further processing (e.g., for measuring the transmit power level of a PA 204 on PA module 152, for measuring the impedance of antenna 40-1 and/or antenna 40-3 in a high band HB, etc.). Further, FRX aggregation switch 258 may couple input terminal 260-3 to output terminal 262-1 to pass the radio-frequency signals coupled off signal path 248 by RF coupler 250 to FRX 50 for further processing (e.g., for measuring the transmit power level of a PA 244 on PA module 154, for measuring the impedance of antenna 40-7 and/or antenna 40-9 in an ultra-high band UHB, etc.).

If desired, FRX aggregation switch 258 may use output terminals 262-1 and 262-2 and feedback paths 128-3 and 128-3 to concurrently convey radio-frequency signals received over any two of feedback paths 176, 240, and 251 to FRX 50 (e.g., FRX aggregation switch 258 may have one or more switch states in which two input terminals 260 are coupled to output terminals 262-1 and 262-2, respectively). This may, for example, allow FRX 50 to concurrently measure the transmit power level of more than one PA module and/or to concurrently measure the impedance of two or more antennas in one or more frequency bands. If desired. FRX aggregation switch 25 may have more than two output terminals 262 coupled to more than two input ports 130 of FRX 50 over respective feedback paths 128 and may concurrently route radio-frequency signals from two or more RF couplers to FRX 50. If desired, FRX aggregation switch 258 may have a single output terminal 262 coupled to a single port 130 of FRX 50 over a corresponding feedback path 128.

In this way, RFFE circuitry 48 may be provided with RF couplers that provide FRX 50 with coupled signals without requiring dedicated RF coupler modules in RFFE circuitry 48, thereby minimizing design complexity, manufacturing cost, power consumption, space consumption, and loss in device 10. Disposing the RF couplers along the transmit chains prior to the antenna selection switch(s) may also serve to reduce the number of RF couplers required in device 10 for coupling signals in each of the bands for each of the antennas relative to implementations where the RF couplers are disposed between the filters and the antennas.

At the same time, by moving the RF couplers to points in the transmit chain(s) prior to the filters (e.g., duplexer 160, filter module 156, filter module 56, filter module 58, etc.), each of RF couplers 57, 114, 174, 214, and 250 only provides coupled radio-frequency signals to FRX 50 within a single frequency band or group of frequency bands. For example, RF coupler 57 provides radio-frequency signals only in high bands HB, RF coupler 114 provides radio-frequency signals only in ultra-high bands UHB, RF coupler 174 provides radio-frequency signals only in low bands LB, RF coupler 214 provides radio-frequency signals only in high bands HB, and RF coupler 250 provides radio-frequency signals only in ultra-high bands UHB to FRX 50. This may serve to maximize isolation between each of the frequency bands and each of the antennas and may eliminate the need for additional filtering on the feedback paths (e.g., feedback paths 72, 115, 176, 240, and 251), since each feedback path only conveys radio-frequency signals within a single frequency band or group of frequency bands.

In addition, integrating the RF couplers into the PA modules in this way may also serve to simplify the RF firmware in device 10, as the RF couplers for each antenna path do not need to change based on which frequencies are being used. Further, integrating the RF couplers into the PA modules may serve to reduce the complexity of automatic power control coexistence with 2.4 GHz Wi-Fi signaling. For example, the filters may serve to reject the Wi-Fi signals and may protect FRX 50 from receiving jammer signals from the Wi-Fi signals over one or more of the feedback paths, thereby allowing for increased power accuracy for adjusting the transmit power level of the cellular transmitter. Such jammer signals would otherwise be directed towards FRX 50 by the RF coupler(s) when the RF coupler(s) are disposed between the antenna(s) and the filters.

Integrating the RF couplers into the PA modules may also readily support UCLA, ULMIMO, and 3TX operations without the need for fast switching of the RF coupler outputs, which could otherwise result in receiver band noise and sensitivity degradation. For example, in ULCA or ENDC scenarios where LB and HB signals are being conveyed at the same time, it can be difficult to isolate the signals, which can form jammers of each other. Moving the RF couplers into the PA modules may help to isolate the signals and may prevent the jammers from being passed to the FRX in these scenarios.

The example of FIGS. 4 and 5 in which the RF couplers are disposed between the band selection switches and antenna selection switches is illustrative and non-limiting. If desired, one or more of the RF couplers may be disposed at a location prior to the band selection switch(es) in the corresponding transmit chain(s) (e.g., directly at the output of the PA(s) on the PA module(s)). For example, RF coupler 57 may be disposed on signal path(s) 66 of PA module 52 at the output of PA(s) 64, RF coupler 114 may be disposed on signal path(s) 112 of PA module 54 at the output of PA(s) 110, RF coupler 174 may be disposed on signal path(s) 162 of PA module 150 at the output of PA(s) 164, RF coupler 214 may be disposed on signal path(s) 202 of PA module 152 at the output of PA(s) 204, and/or RF coupler 250 may be disposed on signal path(s) 242 of PA module 154 at the output of PA(s) 244. However, disposing the RF couplers between the band selection switch and the antenna selection switch may reduce the number of RF couplers as such a location allows each PA on the module to share the same RF coupler. Switches 55, 53, 116, 168, 170, 208, 216, and 252 perform switching on radio-frequency signals transmitted along signal path(s) and may therefore sometimes also be referred to as radio-frequency switches. The radio-frequency signals coupled onto a feedback path by RF couplers 174, 214, 250, 57, and 114 may sometimes be referred to herein as coupled signals, coupled radio-frequency signals, or feedback signals.

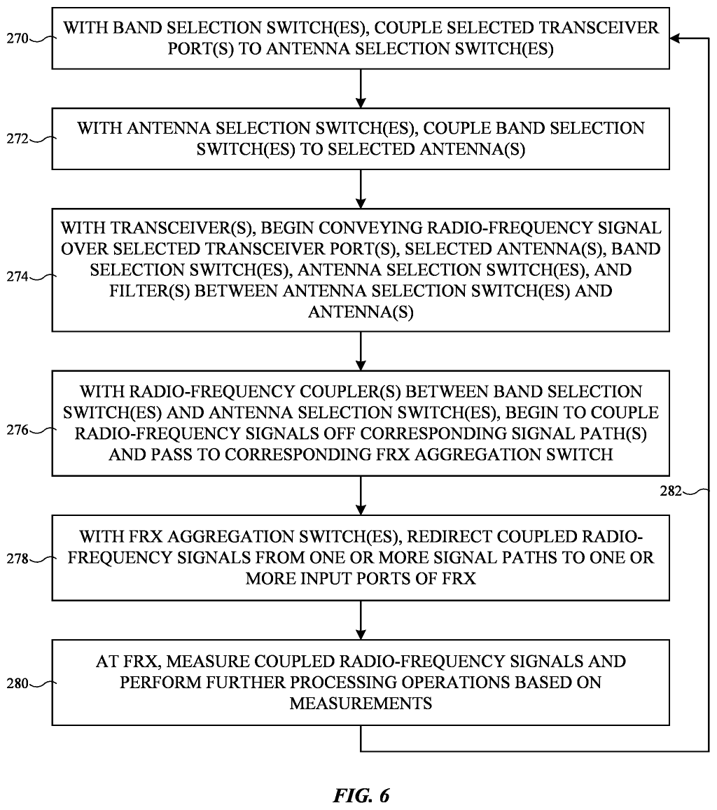

FIG. 6 is a flow chart of operations that may be performed by device 10 to transmit radio-frequency signals over RFFE circuitry 48. At operation 270, control circuitry 28 may control the band selection switch(es) (e.g., band selection switches 168, 208, and/or 55) in one or more of the PA modules (e.g., PA modules 52, 54, 150, 152, and/or 154) of RFFE circuitry 48 to couple selected transceiver port(s) to the corresponding antenna selection switch(es) (e.g., antenna selection switches 170, 216, 252, 53, and/or 116). In other words, the control circuitry may adjust the band selection switch(es) to control which frequency band is amplified by each of the PA modules for transmission.

At operation 272, control circuitry 28 may control the antenna selection switch(es) in one or more of the PA modules in RFFE circuitry 48 (e.g., antenna selection switches 170, 216, 252, 53, and/or 116) to route signals from the corresponding PA module(s) to selected antennas 40 (e.g., one or more of antennas 40-1 through 40-9). In other words, the control circuitry may adjust the antenna selection switch(es) to control which antennas are used by the PA modules for transmission.

At operation 274, one or more transceivers 44 may begin to transmit radio-frequency signals over the selected transceiver port(s), the band selection switch(es), the antenna selection switch(es), the filter(s), and the selected antenna(s). For example, the radio-frequency signals may be transmitted to one or more of the PA modules. The PA module(s) may amplify the radio-frequency signals in one or more frequency bands (e.g., as configured by the band selection switch(es). The PA module(s) may transmit the amplified radio-frequency signals over the selected antenna(s) (e.g., as configured by the antenna selection switch(es)).

At operation 276, the RF coupler(s) in the PA module(s) (e.g., RF couplers 174, 214, 250, 57, and/or 114) may begin to couple radio-frequency signals off their corresponding signal paths and may pass the coupled radio-frequency signals to one or more FRX aggregation switches (e.g., FRX aggregation switch 258 and/or 122) over the corresponding feedback paths (e.g., feedback paths 176, 240, 251, 72, and/or 115).

At operation 278, the FRX aggregation switch(es) may aggregate the coupled radio-frequency signals and may transmit the radio-frequency signals received from one or more of the RF couplers to FRX 50 for further processing (e.g., via one or more feedback paths 128 and one or more input ports 130 of FRX 50).

At operation 280, FRX 50 may measure the coupled radio-frequency signals received from the FRX aggregation switch(es). FRX 50 and/or control circuitry 28 may gather any desired wireless performance metric data from the coupled signals. For example, the FRX and/or the control circuitry may gather transmit power levels, reverse wave information, forward wave information, noise information, scattering parameter values, impedance values, VSWR values, and/or any other desired information from the coupled signals. The control circuitry may perform any desired operations based on the measurements and/or wireless performance metric data. For example, the control circuitry may adjust the transmit power level of subsequently transmitted signals (e.g., by adjusting the transmitter and/or one or more of the power amplifiers on the PA modules), may reduce the transmit power level or a maximum transmit power level (e.g., to satisfy SAR and/or MPE limits), may adjust the tuning of one or more antennas, or may perform any other desired processing operations.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-4 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. An electronic device comprising:
a first antenna;
a second antenna;
a first switch having a first input terminal, a second input terminal, and a first output terminal, the first input terminal being configured to receive a radio-frequency signal of a first frequency and the second input terminal being configured to receive a radio-frequency signal of a second frequency different from the first frequency;
a second switch having a third input terminal, a second output terminal, and a third output terminal, the third input terminal being coupled to the first output terminal over a signal path, the second output terminal being communicatively coupled to the first antenna, and the third output terminal being communicatively coupled to the second antenna; and
a radio-frequency coupler disposed on the signal path between the first switch and the second switch.

2. The electronic device of claim 1, further comprising:
a first filter that couples the second output terminal to the first antenna; and
a second filter that couples the third output terminal to the second antenna.

3. The electronic device of claim 2, further comprising:
a third switch having a fourth input terminal and a fourth output terminal, wherein the fourth input terminal is configured to receive, over an additional signal path, a radio-frequency signal of a third frequency different from the first frequency and the second frequency, the fourth output terminal being communicatively coupled to the first antenna via the first filter.

4. The electronic device of claim 3, wherein the third switch has a fifth output terminal communicatively coupled to the second antenna via the second filter.

5. The electronic device of claim 3, further comprising:
a third antenna, wherein the third switch has a fifth output terminal communicatively coupled to the third antenna.

6. The electronic device of claim 3, further comprising:
a first power amplifier coupled to the first input terminal and configured to amplify the radio-frequency signal of the first frequency;
a second power amplifier coupled to the second input terminal and configured to amplify the radio-frequency signal of the second frequency; and
a third power amplifier communicatively coupled to the additional signal path and configured to amplify the radio-frequency signal of the third frequency.

7. The electronic device of claim 6, further comprising:
a first substrate, wherein the first switch, the second switch, the signal path, the radio-frequency coupler, the first power amplifier, and the second power amplifier are disposed on the first substrate;
a second substrate different from the first substrate, the first filter being disposed on the second substrate;
a third substrate different from the first substrate and the second substrate, the second filter being disposed on the third substrate; and
a fourth substrate different from the first substrate, the second substrate, and the third substrate, wherein the third switch, the additional signal path, and the third power amplifier are disposed on the fourth substrate.

8. The electronic device of claim 3, further comprising:
an additional radio-frequency coupler disposed on the additional signal path; and
a fourth switch having a fifth input terminal, a sixth input terminal, and a fifth output terminal, wherein the fifth input terminal is coupled to the radio-frequency coupler over a first feedback path and the sixth input terminal is coupled to the additional radio-frequency coupler over a second feedback path; and
a feedback receiver communicatively coupled to the fifth output terminal.

9. The electronic device of claim 8, wherein the fourth switch has a sixth output terminal, the feedback receiver has a first input port, the feedback receiver has a second input port, the fifth output terminal is communicatively coupled to the first input port, and the sixth output terminal is communicatively coupled to the second input port.

10. The electronic device of claim 9, wherein the fourth switch is configured to concurrently route a first coupled signal from the radio-frequency coupler to the first input port and a second coupled signal from the additional radio-frequency coupler to the second input port.

11. The electronic device of claim 10, further comprising:
a first substrate, wherein the first switch, the second switch, the signal path, and the radio-frequency coupler are disposed on the first substrate;
a second substrate different from the first substrate, the first filter being disposed on the second substrate; and
a third substrate different from the first substrate and the second substrate, wherein the third switch, the additional signal path, the fourth switch, and the additional radio-frequency coupler are disposed on the fourth substrate.

12. Radio-frequency front end (RFFE) circuitry comprising:
a substrate;
a band selection switch on the substrate;
a plurality of power amplifiers on the substrate, each coupled to a respective input terminal of the band selection switch and each configured to amplify radio-frequency signals of a different respective frequency;
a signal path on the substrate and coupled to an output terminal of the band selection switch;
an antenna selection switch on the substrate and having an input terminal coupled to the signal path, the antenna selection switch being configured to route the radio-frequency signals from the signal path to a selected antenna of a plurality of antennas; and
a radio-frequency coupler on the substrate and disposed on the signal path.

13. The RFFE circuitry of claim 12, further comprising:
a feedback receiver aggregation switch on the substrate, wherein
the feedback receiver aggregation switch has a first input terminal and a second input terminal,
the first input terminal is coupled to the radio-frequency coupler over a feedback path,
the second input terminal is configured to receive additional radio-frequency signals from an additional radio-frequency coupler external to the RFFE circuitry, and
the feedback receiver aggregation switch is configured to communicatively couple the first input terminal and the second input terminal to a feedback receiver.

14. The RFFE circuitry of claim 13, wherein the feedback receiver aggregation switch has an output terminal, a first switch state in which the first input terminal is coupled to the output terminal, and a second switch state in which the second input terminal is coupled to the output terminal.

15. The RFFE circuitry of claim 13, wherein the feedback receiver aggregation switch has a first output terminal and a second out terminal.

16. The RFFE circuitry of claim 15, wherein the feedback receiver aggregation switch is configured to couple the first input terminal to the first output terminal concurrent with the second input terminal being coupled to the second output terminal.

17. The RFFE circuitry of claim 13, wherein the additional radio-frequency signals and the radio-frequency signals are at different frequencies.

18. The RFFE circuitry of claim 12, wherein the radio-frequency coupler is configured to transmit, over a feedback path, a portion of the radio-frequency signals from the signal path to a feedback receiver aggregation switch external to the RFFE circuitry.

19. A method of operating wireless circuitry to wirelessly transmit a radio-frequency signal, the method comprising:
amplifying, using a power amplifier, the radio-frequency signal;
transmitting, using a first switch, the radio-frequency signal from the power amplifier onto a signal path;
coupling, using a radio-frequency coupler, a portion of the radio-frequency signal off the signal path;
transmitting, using a second switch, the radio-frequency signal from the signal path towards a selected antenna of a plurality of antennas;
filtering the radio-frequency signal using a filter coupled between the second switch and the selected antenna; and
transmitting, using the selected antenna, the radio-frequency signal.

20. The method of claim 19, further comprising:
routing, using a third switch, the portion of the radio-frequency signal coupled off the signal path from the radio-frequency coupler to a feedback receiver; and
routing, using the third switch, an additional radio-frequency signal from an additional radio-frequency coupler to the feedback receiver.
